(19) United States
(12) Patent Application Publication
(10) Pub. No.: US 2024/0303525 A1
(43) Pub. Date: Sep. 12, 2024

(54) QUANTUM COMPUTATION METHOD AND QUANTUM OPERATION CONTROL LAYOUT

(71) Applicant: PARITY QUANTUM COMPUTING GMBH

(72) Inventor: Wolfgang LECHNER, Rum (AT)

(21) Appl. No.: 18/271,987

(22) PCT Filed: Jan. 14, 2021
(86) PCT No.: PCT/EP2021/050710

§ 371 Date: Jul. 12, 2023

(51) Int. Cl. G06N 10/60

(52) U.S. Cl. CPC G06N 10/60

(57) ABSTRACT

According to an embodiment, a method of performing a quantum computation on a quantum system is provided. The method includes encoding a computational problem into a problem Hamiltonian of constituents of the quantum system. The method includes mapping a side condition or side conditions associated with the computational problem to an exchange Hamiltonian of a first part of the constituents of the quantum system. The method includes initializing the constituents of the quantum system in an initial state. The method includes evolving the quantum system by interactions of the constituents of the quantum system. The interactions include interactions determined by a final Hamiltonian, interactions determined by the exchange Hamiltonian, and interactions determined by a driver Hamiltonian. The final Hamiltonian is the sum of the problem Hamiltonian and of a short-range Hamiltonian. The driver Hamiltonian is a Hamiltonian of a second part of the constituents of the quantum system. The method includes measuring at least a portion of the constituents of the quantum system to obtain a read-out.

### FIELD

Embodiments described herein relate to a method of performing a quantum computation on a quantum system. Further embodiments are directed to an apparatus and a system for performing a quantum computation on a quantum system, in particularly for performing the quantum computation according to the method. Further embodiments described herein relate to a method of determining a quantum operation control layout for a quantum computation on a quantum system, to the quantum operation control layout itself, to a computer program product including the quantum operation control layout, and to a method of performing the quantum computation on the quantum system using the quantum operation control layout. Further embodiments are directed to apparatuses or systems for determining the quantum operation control layout for the quantum computation on a quantum system and/or for performing the quantum computation on the quantum system using the quantum operation control layout, in particular apparatuses or systems configured to carry out the methods described herein, and to uses of the apparatuses or systems.

### BACKGROUND

Computing devices based on classical information processing, i.e., computing devices not making use of quantum mechanical effects, once started out as hard-wired calculators which could only perform specific operations. The transition to fully programmable computers revolutionized the field and started the information age. Currently, quantum computing devices, i.e., computing devices which, possibly in addition to using classical information processing, make use of quantum mechanical effects to solve computational problems, are still mostly in stages comparable to those of hard-wired calculators in that they can only tackle computational problems for which they are particularly designed.

EP 3 113 084 B1 describes a method and apparatus for solving computational problems using a quantum system. This quantum computing method/apparatus receives a computational problem, in particular an NP hard computational problem or an NP complete computational problem, such as the (classical) Ising spin model with N spins and all-to-all pairwise interactions. The quantum method/apparatus encodes the computational problem into a single-body problem Hamiltonian of the quantum system with adjustable parameters. For instance, in the case of the (classical) Ising spin model with N spins and all-to-all pairwise interactions between the N spins, each term of the single-body problem Hamiltonian may be regarded as corresponding to one of the pairwise interactions, and so there are N(N−1)/2 single-body terms of the problem Hamiltonian acting on a corresponding number of quantum bits (qubits) of the quantum system, and there is a like number of adjustable parameters. The qubits of the quantum system represent the parity of the spins of the Ising spin model, wherein the state |0 [symbol] indicates anti-parallel alignment of the corresponding spins of the Ising spin model, and the state |1 [symbol] indicates parallel alignment.

In addition, a short-range Hamiltonian is provided in EP 3 113 084 B1 to compensate for the increased number of degrees of freedom of the quantum system as compared to the Ising spin model, the short-range Hamiltonian being a sum of at least N(N−1)/2−N constraint Hamiltonians, wherein each constraint Hamiltonian acts with a constraint strength Con at most four qubits forming a plaquette of a square lattice that contains the qubits of the quantum system. The constraint Hamiltonians ensure consistency with the Ising spin model in that they enforce the presence of an even number (zero, two, etc.) of states |0 [symbol] within subsets of qubits that correspond to spins with anti-parallel alignment in closed loops over spins in the Ising spin model.

A final Hamiltonian is the sum of the problem Hamiltonian and of the short-range Hamiltonian. The ground state of the final Hamiltonian, or at least a thermal state close to that ground state, contains information about a solution to the computational problem that is encoded in the parameters of the problem Hamiltonian. Measuring the quantum system in such a state can reveal information about the solution to the computational problem. The ground state of the final Hamiltonian, or thermal state close to the ground state, can be reached by quantum annealing, i.e. an adiabatic sweep from the ground state of an initial Hamiltonian to the ground state of the final Hamiltonian as described in EP 3 113 084 B1. Alternatively, the ground state may be reached by counter-diabatic driving using a Hamiltonian with an additional counter-diabatic part as described in WO 2020/259813 A1. The adiabatic quantum computation and the counter-diabatic quantum computation can both be regarded as an analog quantum computation. A digital version of the quantum computation using quantum gates is described in WO 2020/156680 A1. A state approximating the ground state of the final Hamiltonian can be reached by a sequence of unitary operators acting on an initial state, wherein the unitary operators are propagators of a driver Hamiltonian, problem Hamiltonian and short range-Hamiltonian, wherein the sequence of unitary operators and their parameters can be optimized using a classical feed-forward algorithm, and wherein the unitary operators can be implemented by a vastly parallelizable application of quantum gates acting locally or on nearest neighbors of qubits in a square lattice.

Since the (classical) computational problem is encoded in the parameters of the problem Hamiltonian, these methods and apparatuses provide for a fully programmable quantum computing architecture, in contrast to the hard-wired quantum computing devices. The quantum computing architecture is also scalable. However, the scaling can be resource-demanding. For instance, when the number N of spins of the (classical) Ising spin model grows, the size of the quantum system (number of qubits) grows quadratically with N. In addition, EP 3 113 084 B1 describes that its method/apparatus can be applied to Ising spin models with three-body interactions, to be implemented in a three-dimensional lattice for the qubits of the quantum system, and mentions that the method/apparatus could be generalized to d-body interactions. Quantum operations on a quantum system of qubits arranged on a three-dimensional lattice may be possible, yet could be difficult to perform. Moreover, d-body interactions would lead to an implementation in even higher-dimensional lattices following the teaching of EP 3 113 084 B1, and this can be impractical due to the limited number of spatial dimensions of our world.

PCT/EP2020/069416 describes a way of reducing the resource demand of these fully programmable quantum computing architectures, wherein the size of the quantum system (number of qubits) grows only with the number K of interaction terms in the (classical) Ising spin model, which can be substantially lower than a quadratic growth with the number N of spins of the (classical) Ising spin model. In addition, PCT/EP2020/069416 describes a way of dealing with arbitrary d-body interactions in the (classical) Ising spin model, and still carry out the quantum computation on constituents (particularly qubits) that are arranged in a two-dimensional surface. To these ends, a quantum operation control layout, and methods and systems of determining and using it are provided. The quantum operation control layout can be loaded into a quantum processing unit to control the quantum operations of a quantum computation, and can be viewed as a control program for the quantum computation. PCT/EP2020/069416 also describes a way of dealing with side conditions on individual interactions in the (classical) Ising spin model. Such individual interactions in the (classical) Ising spin model that are subject to a side condition need not be represented by a constituent of the quantum system, and their influence can be absorbed in the interactions between constituents of the quantum system.

However, optimization problems or other computational problems with side conditions, which are often encountered in real-world applications, can lead to more complex side conditions that concern several interactions jointly, and not only individual interactions between spins of the (classical) Ising spin model. Therefore, there is a need for improvement.

### SUMMARY

According to an embodiment, a method of performing a quantum computation on a quantum system is provided. The method includes encoding a computational problem into a problem Hamiltonian of constituents of the quantum system. The method includes mapping a side condition or side conditions associated with the computational problem to an exchange Hamiltonian of a first part of the constituents of the quantum system. The method includes initializing the constituents of the quantum system in an initial state. The method includes evolving the quantum system by interactions of the constituents of the quantum system. The interactions include interactions determined by a final Hamiltonian, interactions determined by the exchange Hamiltonian, and interactions determined by a driver Hamiltonian. The final Hamiltonian is the sum of the problem Hamiltonian and of a short-range Hamiltonian. The driver Hamiltonian is a Hamiltonian of a second part of the constituents of the quantum system. The method includes measuring at least a portion of the constituents of the quantum system to obtain a read-out.

According to an embodiment, an apparatus for performing a quantum computation on a quantum system is provided. The apparatus includes the quantum system, including constituents of the quantum system that form a first part and a second part. The apparatus includes an encoder configured for encoding a computational problem into a problem Hamiltonian of the constituents of the quantum system, and configured for mapping a side condition or side conditions associated with the computational problem to an exchange Hamiltonian of the first part of the constituents of the quantum system. The apparatus includes a quantum processing unit configured for initializing the constituents of the quantum system in an initial state, and configured for evolving the quantum system by interactions of the constituents of the quantum system, wherein the interactions include interactions determined by a final Hamiltonian, interactions determined by the exchange Hamiltonian, and interactions determined by a driver Hamiltonian, wherein the final Hamiltonian is the sum of the problem Hamiltonian and of a short-range Hamiltonian, and the driver Hamiltonian is a Hamiltonian of the second part of the constituents of the quantum system. The apparatus includes a measurement unit configured for measuring at least a portion of the constituents of the quantum system to obtain a read-out.

According to other embodiments, a method of determining a quantum operation control layout for a quantum computation on a quantum system is provided. The quantum computation is to be carried out on constituents of the quantum system arranged in accordance with a mesh having vertices, first cells and second cells. The vertices of the mesh represent possible sites for the constituents of the quantum system. Each cell of the first cells indicates that first quantum interactions between constituents of the quantum system arranged in that cell are possible during the quantum computation. Each cell of the second cells indicates that second quantum interactions between constituents of the quantum system arranged in that cell are possible during the quantum computation. The method includes providing a data set including data representing hyperedges of a hypergraph and including data representing a set of one or more fixed hyperedge relations. A fixed hyperedge relation includes a set of hyperedges of the hypergraph. The method includes determining a set of generalized cycles, the generalized cycles containing hyperedges of the hypergraph or containing hyperedges of an enlarged hypergraph, the enlarged hypergraph at least including the hyperedges of the hypergraph and an additional hyperedge. Therein, a maximal length of generalized cycles of the set of generalized cycles is not greater than a maximal vertex number of the first cells of the mesh. The method includes determining a mesh mapping that maps data representing the hyperedges of the hypergraph or of the enlarged hypergraph to the vertices of the mesh, wherein each generalized cycle of a constraining subset of the set of generalized cycles consists of hyperedges mapped to a cell of the first cells of the mesh and wherein each fixed hyperedge relation of the set of one or more fixed hyperedge relations consists of hyperedges mapped to a cell of the second cells of the mesh. The method includes generating the quantum operation control layout. The quantum operation control layout includes data indicating layout vertices of the mesh. Each layout vertex corresponds to a hyperedge mapped according to the mesh mapping, including data indicating first layout vertex sets, each first layout vertex set consisting of layout vertices within a cell of the first cells of the mesh that correspond to a generalized cycle of the constraining subset of generalized cycles, and including data indicating one or more second layout vertex sets, each second layout vertex set consisting of layout vertices within a cell of the second cells of the mesh that correspond to a fixed hyperedge relation of the set of one or more fixed hyperedge relations.

According to a further embodiment, a quantum operation control layout for controlling a quantum computation on a quantum system is provided. The quantum computation is to be carried out on constituents of the quantum system arranged in accordance with a mesh. The mesh has vertices, first cells and second cells. The vertices of the mesh represent possible sites for the constituents of the quantum system. Each cell of the first cells of the mesh indicates that first quantum interactions between constituents of the quantum system arranged in that cell are possible during the quantum computation. Each cell of the second cells of the mesh indicates that second quantum interactions between constituents of the quantum system arranged in that cell are possible during the quantum computation. The first quantum interactions may be different from the second quantum interactions. The quantum operation control layout includes data indicating layout vertices of the mesh, data indicating first layout vertex sets, wherein each first layout vertex set consists of layout vertices within a first cell of the mesh, and data indicating one or more second layout vertex sets, wherein each second layout vertex set consists of layout vertices within a second cell of the mesh.

According to a further embodiment, a method of performing a quantum computation on a quantum system is provided. The quantum computation is carried out on constituents of the quantum system. The method includes providing a quantum operation control layout as described herein. The method includes providing the constituents of the quantum system in a spatial arrangement such that there is a constituent for every layout vertex of the mesh. Therein, for each first layout vertex set, first quantum interactions are possible between constituents corresponding to layout vertices of that first layout vertex set, and, for each second layout vertex set, second quantum interactions are possible between constituents corresponding to layout vertices of that second layout vertex set. The first quantum interactions may be different from the second quantum interactions. The method includes, for each layout vertex associated with a non-zero weight, applying a local field to the constituent corresponding to that layout vertex. The local field may be determined by problem Hamiltonian. The method includes, for each first layout vertex set, performing first quantum interactions between constituents corresponding to the layout vertices of that first layout vertex set. The first quantum interactions may be determined by a short-range Hamiltonian. The method includes, for each second layout vertex set, performing second quantum interactions between constituents corresponding to the layout vertices of that second layout vertex set. The second quantum interactions may be determined by an exchange Hamiltonian. The method includes measuring some or all of the constituents of the quantum system.

Embodiments are also directed to methods for operating the systems described herein, and to the use of the systems to perform the methods according to the embodiments described herein.

Further advantages, features, aspects and details that can be combined with embodiments described herein are evident from the dependent claims, the description and the drawings.

### BRIEF DESCRIPTION OF THE DRAWINGS

A full and enabling disclosure to one of ordinary skill in the art is set forth more particularly in the remainder of the specification including reference to the accompanying drawings wherein:

FIG. 1 schematically shows a quantum system, its constituents, and interactions between the constituents, which may be used in embodiments described herein;

FIG. 2 illustrates three functions determining strengths of three Hamiltonians, which may be used in embodiments described herein;

FIGS. 3 and 4 show energy spectra of intermediate Hamiltonians over time, which may be used in embodiments described herein;

FIG. 5 schematically shows a quantum system, its constituents, and interactions between the constituents, which may be used in embodiments described herein;

FIG. 6 shows a graphical representation of an exemplary quantum operation control layout in accordance with embodiments described herein;

FIG. 7 schematically shows an apparatus for quantum computation, a system for determining a quantum operation control layout, and a system for determining a solution of a computational problem with side condition(s) according to embodiments described herein;

FIG. 8 schematically shows a method of determining a quantum operation control layout according to embodiments described herein; and

FIG. 9 schematically shows a method performing a quantum computation according to embodiments described herein.

### DETAILED DESCRIPTION

Reference will now be made in detail to the various exemplary embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

Within the description of the drawings, the same reference numbers refer to the same or similar components. Generally, only the differences with respect to the individual embodiments are described. The structures shown in the drawings are not necessarily depicted true to scale, and may contain details drawn in an exaggerated way to allow for a better understanding of the embodiments.

Some embodiments described herein relate to a method of performing a quantum computation on a quantum system, and to an apparatus of performing a quantum computation on a quantum system.

### Input of the Method

Many computational problems of interest, among them NP-hard optimization problems but also NP-complete decision problems, can be mapped to an Ising spin model, the decision form of which is NP-complete itself. Specifically, such problems may be mapped to the problem of finding the ground state energy of the classical Hamiltonian function H(s₁, . . . , s_{N}) Σ_{i<j}^{N}Jᵢⱼsᵢsⱼ+Σᵢ^{N}hᵢsᵢ or of the corresponding quantum Hamiltonian operator H(σ_{z}⁽¹⁾, . . . , σ_{z}^{(N)})=Σ_{i<j}^{N}Jᵢⱼσ_{z}⁽ⁱ⁾σ_{z}^{(j)}+Σᵢ^{N}hᵢσ_{z}⁽ⁱ⁾, wherein the Ising spin model may involve long-range interactions. A distinction between the classical and the quantum version of spin models need not be made herein, and only the quantum Hamiltonian operators will be specified and called “Hamiltonian” for brevity.

Many of the aforementioned computational problems map more naturally, i.e., with decreased number of spins, to spin models which do not only involve pairwise interactions, but which involve k-body interactions with k larger than two as well. That is, the computational problem at hand may be rephrased (mapped to) the problem of finding the ground state energy of the spin model Hamiltonian H(σ_{z}⁽¹⁾, . . . , σ_{z}⁽¹⁾)=Σᵢ^{N}hᵢσ_{z}⁽ⁱ⁾+Σ_{i<j}^{N}Jᵢⱼσ_{z}⁽ⁱ⁾σ_{z}^{(j)}+Σ_{i<j<k}^{N}Rᵢⱼₖσ_{z}⁽ⁱ⁾σ_{z}^{(j)}σ_{z}^{(k)}+Σ_{i<j<k<l}Tᵢⱼₖₗσ_{z}⁽ⁱ⁾σ_{z}^{(j)}σ_{z}^{(k)}σ_{z}^{(l)}+ . . . , wherein the spin model Hamiltonian contains k-body interactions with k being larger than one and smaller than or equal to N, and may contain k-body interactions with k being larger than two. The vector h, matrix J, and tensors R, T, etc. contain weights of the k-body interactions, indicating the interaction strengths. The number K shall stand for the number of non-zero weights, which specifies the number of summand terms in the spin model Hamiltonian. The non-zero weights may be integer numbers, e.g., all being 1 or −1, or may be arbitrary real numbers.

The aforementioned computational problems may be subject to side conditions. When such a computational problem is mapped to the spin model, the side conditions associated with the computational problem are mapped to side conditions of/associated with the spin model. The spin model Hamiltonian H(σ_{z}⁽¹⁾, . . . , σ_{z}^{(N)})=Σᵢ^{N}hᵢσ_{z}⁽ⁱ⁾+Σi<j^{N}Jᵢⱼσ_{z}⁽ⁱ⁾σ_{z}^{(j)}+Σ_{i<j<k}^{N}Rᵢⱼₖσ_{z}⁽ⁱ⁾σ_{z}^{(j)}σ_{z}^{(k)}+Σ_{i<j<k<l}Tᵢⱼₖₗσ_{z}⁽ⁱ⁾σ_{z}^{(j)}σ_{z}^{(k)}σ_{z}^{(l)}+ . . . may be subject to one or more side conditions of the form Σᵢσ_{z}⁽ⁱ⁾+Σ_{i<j}σ_{z}⁽ⁱ⁾σ_{z}^{(j)}+Σ_{i<j<k}σ_{z}⁽ⁱ⁾σ_{z}^{(j)}σ_{z}^{(k)}+Σ_{i<j<k<l}σ_{z}⁽ⁱ⁾σ_{z}^{(j)}σ_{z}^{(k)}σ_{z}^{(l)}+ . . . =c, wherein there are n summands in total (and some of the sums can be empty), and the constant c is from the range [−n, n]. If n=1, or if c=n or c=−n, then the side conditions are equivalent to individual side conditions on the n summands. There can be two or more summands in at least one side condition of the spin model, i.e., n≥2, and/or the constant c can be in the range from [−n+2, n−2].

Given a list of side conditions to which the spin model Hamiltonian is subject, the list containing one or more side conditions of the above form, then let nₘₐₓ be the largest number of summands in any of the side conditions of that list. The method may include reducing nₘₐₓ to be as low as possible. Reducing nₘₐₓ to be as low as possible may involve algebraic transformations of the linear equations representing the side conditions. For instance, consider a list with the following two side conditions on four spins of the spin model Hamiltonian, wherein the four spins in question are labeled from 1 to 4 for simplicity: σ_{z}⁽¹⁾σ_{z}⁽²⁾+σ_{z}⁽¹⁾σ_{z}⁽²⁾σ_{z}⁽³⁾=c₁=0 and σ_{z}⁽¹⁾σ_{z}⁽²⁾+σ_{z}⁽¹⁾σ_{z}⁽²⁾σ_{z}⁽³⁾+σ_{z}⁽²⁾σ_{z}⁽³⁾σ_{z}⁽⁴⁾=c₂=1. Then nₘₐₓ=3 for this list. But algebraic computation transforms the second linear equation to σ_{z}⁽²⁾σ_{z}⁽³⁾σ_{z}⁽⁴⁾=c₂−c₁=1. Therefore, the list of side conditions can be transformed to a standard form with lowest nₘₐₓ, namely σ_{z}⁽¹⁾σ_{z}⁽²⁾+σ_{z}⁽¹⁾σ_{z}⁽²⁾σ_{z}⁽³⁾=0 and σ_{z}⁽²⁾σ_{z}⁽³⁾σ_{z}⁽⁴⁾=1 in the example, where nₘₐₓ is 2. When the list of side conditions is such that nₘₐₓ is lowest, nₘₐₓ may be larger than or equal to two.

In the method, the computational problem may be mapped to the spin model Hamiltonian with arbitrary k-body interactions. The spin model Hamiltonian can be regarded as an auxiliary computational problem. The side conditions associated with the computational problem, i.e., the side conditions to which the computational problem is subject, may be mapped to a list of side conditions of the spin model Hamiltonian. The list of side conditions may be in a standard format or be brought into a standard format. The standard format may, e.g., be a format in which nₘₐₓ, the largest number of summands in any of the side conditions of the list, is minimal.

### Quantum System

The quantum system is a physical system exhibiting quantum effects. That means, the quantum system is a real-world object. The quantum system includes constituents. The constituents of the quantum system are physical quantum entities themselves, and can be regarded as smaller d-level quantum systems that jointly form the quantum system. Specifically, the constituents of the quantum system can be qubits. A qubit shall be understood as a physical entity that realizes a two-level quantum system. The constituents may be d-level quantum systems (“qudits”) with d>2, wherein only two levels of the d levels might be used.

The quantum system can be in different quantum states, such as an initial quantum state (in which it may be prepared at the beginning of a quantum computation) and a final quantum (in which it may end up due to the quantum computation). The final quantum state can be the ground state of a final Hamiltonian of the quantum system. A Hamiltonian operator is an observable (i.e., a measurable quantity) of a quantum system whose values represent the energy of the quantum system. Herein, the term “Hamiltonian” will be used as an abbreviation of “Hamiltonian operator”. The quantum system can be evolved from an initial quantum state to a ground state of a final Hamiltonian of the quantum system. Such an evolution is a real-world process, and particularly a controlled technical process (quantum computation) which brings the quantum system from an initial quantum state to an a priori unknown final quantum state that contains information about the solution to the computational problem. This information can be revealed by measuring the quantum system or a part thereof, i.e., at least some of its constituents. The act of measuring is a physical/technical process. Measurements allow to obtain a read-out of the quantum system. A read-out of a quantum system is a set of measurement values obtained by measurements of constituents of the quantum system, involving physical interactions with the constituents.

The quantum system may include K qubits, wherein K may be at least 100, at least 1.000 or at least 10.000. K may be from 100 and 10.000, or from 100 to 100.000, but K may be larger than 100.000. It shall be understood that the quantum systems shown in the figures and described in examples may be much smaller for illustrative and explanatory purposes, but shall not be understood to provide any limitation.

### Problem Hamiltonian

The method comprises encoding the computational problem into a problem Hamiltonian, H_{prob}, of the quantum system. The problem Hamiltonian may be a single-body Hamiltonian. The problem Hamiltonian may have the form H_{prob}=Σ_{i∈[A]}Pᵢ\tilde{σ}_{z}⁽ⁱ⁾. Therein, each Pᵢ is a parameter, and each \tilde{σ}_{z}⁽ⁱ⁾ is a Pauli operator acting on the i-th constituent of the quantum system, and [A] is an index set uniquely indexing all constituents of the quantum system or at least those constituents participating in the quantum computation. Encoding the computational problem into the problem Hamiltonian may include determining, from the computational problem, a problem-encoding configuration for the parameters Pᵢ of the problem Hamiltonian.

Encoding the computational problem into the problem Hamiltonian of constituents of the quantum system may include mapping the computational problem to the spin model Hamiltonian with arbitrary k-body interactions. Then, each summand Pᵢ\tilde{σ}_{z}⁽ⁱ⁾ of the problem Hamiltonian can be associated with one summand of the spin model Hamiltonian, wherein each Pᵢ is equal to one coefficient of the vector h, matrix J, or tensors R, T, etc., and each \tilde{σ}_{z}⁽ⁱ⁾ corresponds the product of σ_{z}-operators belonging to that coefficient. For instance, if the spin model Hamiltonian were H=h₁σ_{z}⁽¹⁾+J₂₃σ_{z}⁽²⁾σ_{z}⁽³⁾+R₁₂₃σ_{z}⁽¹⁾σ_{z}⁽²⁾σ_{z}⁽³⁾ then the problem Hamiltonian would be H_{prob}=Σᵢ₌₁³Pᵢ\tilde{σ}_{z}⁽ⁱ⁾ with P₁=h₁, \tilde{σ}_{z}⁽¹⁾ [symbol] \tilde{σ}_{z}⁽¹⁾, P₂=J₂₃, \tilde{σ}_{z}⁽²⁾ [symbol] σ_{z}⁽²⁾σ_{z}⁽³⁾, P₃=R₁₂₃, \tilde{σ}_{z}⁽³⁾ [symbol] σ_{z}⁽¹⁾σ_{z}⁽²⁾σ_{z}⁽³⁾. But encoding the computational problem into the problem Hamiltonian may alternatively be made directly, without mapping the computational problem to the spin model Hamiltonian.

### Exchange Hamiltonian

The method includes mapping a side condition or side conditions associated with the computational problem to an exchange Hamiltonian, H_{exchange}, of a first part of the constituents of the quantum system. Mapping the side condition(s) may include mapping each side condition of a list of side conditions associated with the computational problem to the exchange Hamiltonian. Mapping the side condition(s) of the computational problem to the exchange Hamiltonian may include mapping the side condition(s), such as each side condition of a list of side conditions associated with the computational problem, to a list of side conditions of the spin model Hamiltonian. Therein, the list of side conditions may be brought in some standard format, as described herein.

An r-th side condition of the spin model Hamiltonian of the form Σᵢσ_{z}⁽ⁱ⁾+Σ_{i<j}σ_{z}⁽ⁱ⁾σ_{z}^{(j)}+Σ_{i<j<k}σ_{z}⁽ⁱ⁾σ_{z}^{(j)}σ_{z}^{(k)}+Σ_{i<j<k<l}σ_{z}⁽ⁱ⁾σ_{z}^{(j)}σ_{z}^{(k)}σ_{z}^{(l)}+ . . . cᵣ, may be mapped to Σ_{i∈[SC}_{ᵣ}_{]}\tilde{σ}_{z}⁽ⁱ⁾=cᵣ, wherein each \tilde{σ}_{z}⁽ⁱ⁾ corresponds a product of σ_{z}-operators of one of the summands of the r-th side condition of the spin model Hamiltonian, as in the mapping of the spin model Hamiltonian to the problem Hamiltonian. Therein, [SCᵣ] is an index set of constituents of the quantum system on which the Pauli operators act, i.e., of the constituents of the quantum system affected by the r-th side condition in question. The exchange Hamiltonian may be sum of summand exchange Hamiltonians H_{exchange}=ΣᵣH_{exchange}^{(r)}, where there is one summand exchange Hamiltonian for each side condition. Each summand exchange Hamiltonian may leave its side condition invariant, i.e. the side condition with which that summand exchange Hamiltonian is associated. This invariance means that Σ_{i∈[SC}_{ᵣ}_{]}\tilde{σ}_{z}⁽ⁱ⁾=cᵣ and that the commutator of Σ_{i∈[SC}_{ᵣ}_{]}\tilde{σ}_{z}⁽ⁱ⁾ and H_{exchange}^{(r)} is zero, so if the r-th side condition is initially fulfilled, then the action of the r-th summand exchange Hamiltonian conserves the fulfilment of the r-th side condition. If each side condition of a list of side conditions is fulfilled initially, then the action of the exchange Hamiltonian will leave all of them invariant. Dynamics induced by the exchange Hamiltonian will preserve the fulfilment of the side condition or of the side conditions, i.e., of each side condition of a list of one or more side conditions. The first part of the constituents of the quantum system is a set of constituents indexed by the index set [SC]=Uᵣ[SCᵣ], i.e., by the union of all index sets of the constituents on which the Pauli operators associated with the r-th side condition act.

Summand exchange Hamiltonians may include, or consist of, first order hopping terms of the form H_{exchange}^{(r)}=Σ_{<i,j>,i,j∈[SC}_{ᵣ}_{]}\tilde{σ}₊⁽ⁱ⁾\tilde{σ}₋^{(j)}+\tilde{σ}₋⁽ⁱ⁾\tilde{σ}₊^{(j)}, wherein <i,j> designates pairs of constituents that are nearest neighbors, and \tilde{σ}₊=\tilde{σ}ₓ+i\tilde{σ}ⱼ is a spin raising operator and \tilde{σ}₋=\tilde{σ}ₓ−i\tilde{σ}ⱼ a spin lowering operator, sometimes called ladder operators or creation and annihilation operators. The hopping terms may synonymously be called exchange terms. A summand exchange Hamiltonian H_{exchange}^{(r)} might include first order hopping terms acting on constituents which are not nearest neighbors, wherein the constituents are indexed by the index set [SCᵣ]. A summand exchange Hamiltonian might include higher order hopping terms of the form Σ_{i,j, . . . , k,l, . . . ∈[SC}_{ᵣ}_{]}\tilde{σ}₊⁽ⁱ⁾\tilde{σ}₊^{(j)} . . . \tilde{σ}₋^{(k)}\tilde{σ}₋^{(l)} . . . +\tilde{σ}₋⁽ⁱ⁾\tilde{σ}₋^{(j)} . . . \tilde{σ}₊^{(k)}\tilde{σ}₊^{(l)} . . . , wherein the a hopping term is of order n if the products of raising and lowering operators include n raising and n lowering operators.

The exchange Hamiltonian may be represented by a sum of nearest-neighbor hopping terms, in particular nearest-neighbor first order hopping terms. The nearest-neighbor first order hopping terms may have the form \tilde{σ}₊⁽ⁱ⁾\tilde{σ}₋^{(j)}+\tilde{σ}₋⁽ⁱ⁾\tilde{σ}₊^{(j)}, wherein i and j are indices designating constituents that are nearest-neighbors in an arrangement of the quantum system, and wherein \tilde{σ}₊ is a spin raising operator and \tilde{σ}₋ is a spin lowering operator. The exchange Hamiltonian may be a sum of summand exchange Hamiltonians, and may specifically have the form H_{S}=ΣᵣH_{exchange}^{(r)}=Σ_{<i,j>,i,j∈[SC}_{ᵣ}_{]}\tilde{σ}₊⁽ⁱ⁾\tilde{σ}₋^{(j)}+\tilde{σ}₋⁽ⁱ⁾\tilde{σ}₊^{(j)}. The first part of the constituents of the quantum system may be a set of constituents indexed by an index set [SC] that is the union of the index sets [SCᵣ].

### Driver Hamiltonian

The method features a driver Hamiltonian, H_{drive}. The driver Hamiltonian is a Hamiltonian of a second part of the constituents of the quantum system. The first part of the constituents of the quantum system may be disjoint from the second part of the constituents of the quantum system. In other words, it may be the case that no constituent of the quantum system belongs to both the first and second parts of the constituents of the quantum system. The first part of the constituents of the quantum system may be complementary to the second part of the constituents of the quantum system. In other words, the first and second parts may be disjoint and the union of the first and second parts of constituents is the entire set of constituents of the quantum system. The second part of the constituents of the quantum system may be set of constituents indexed by the index set [UC]. Let [A] be an index set uniquely indexing all constituents of the quantum system, then [SC]∪[UC]=[A] and/or [SC]∩[UC]=Ø may hold.

The driver Hamiltonian may be a single-body Hamiltonian. The driver Hamiltonian may have the form H_{drive}=Σ_{i∈[UC]}Dᵢ\tilde{σ}ₓ⁽ⁱ⁾. Therein, each Dᵢ is a parameter, and each \tilde{σ}ₓ⁽ⁱ⁾ is a Pauli operator acting on the i-th constituent of the second part of constituents of the quantum system. Particularly, Dᵢ=D can hold for all i, and D may be 1, in which case H_{drive}=Σ_{i∈[UC]}\tilde{σ}ₓ⁽ⁱ⁾.

Herein, specific forms of the problem Hamiltonian, exchange Hamiltonian, and driver Hamiltonian have been given, wherein the problem Hamiltonian employed Pauli operators if, the driver Hamiltonian employed Pauli operators \tilde{σ}ₓ, and the spin raising and lowering operators of the exchange Hamiltonian were specified in view of this choice as well. It shall be understood that this choice of types of Pauli operators is without loss of generality in that corresponding orientations (x, y, z) can be chosen freely, or else the types Pauli operators can be permuted. The type of Pauli operators employed for the driver Hamiltonian is different from the type of Pauli operators employed for the problem Hamiltonian.

### Short-Range Hamiltonian

A short-range Hamiltonian, H_{S}, can compensate for the increased number of degrees of freedom of the quantum system as compared to the Ising spin model to which the computational problem to be solved is mapped. The short-range Hamiltonian may be a sum of constraint Hamiltonians. The constraint Hamiltonians can ensure the consistency with the Ising spin model, as described in EP 3 113 084 B1 and PCT/EP2020/069416. The short-range Hamiltonian may be a d-body Hamiltonian. Therein, d is a natural number, wherein d may be from the range 2-12, for instance 3, 4 or 6. The number d may be smaller than or equal to 4. The number d may be larger than or equal to 3. A d-body Hamiltonian may involve interactions within groups of d or less constituents of the quantum system. A Hamiltonian being the sum of constraint Hamiltonians is a d-body Hamiltonian when each constraint Hamiltonian represents a joint interaction within a group of d or less constituents and when there is at least one constraint Hamiltonian representing a joint interaction within a group of d constituents. The number d may be independent of the computational problem. Each constraint Hamiltonian may involve \tilde{σ}_{z} operators acting on at most d constituents. Each constraint Hamiltonian may have the form C\tilde{σ}_{z} . . . \tilde{σ}_{z}, wherein each constraint Hamiltonian may act with a constraint strength C on at most d constituents.

The number d may depend on the spatial arrangement of the constituents of the quantum system. For instance, if the constituents are arranged in a two-dimensional lattice, then d may be four if the two-dimensional lattice is a quadrangular lattice, and may be six if the two-dimensional lattice is a hexagonal lattice.

As described in EP 3 113 084 B1, joint quantum interactions between a group of constituents may only realizable if the constituents of that group are close to each other (short-range interactions). The short-range Hamiltonian may refer to a Hamiltonian representing joint interactions within groups of constituents, wherein no interactions occur between constituents which are distanced from each other by a distance greater than an interaction cut-off distance. The interaction cut-off distance may be a constant distance. The interaction cut-off distance may be much smaller compared to a maximal constituent distance between constituents in the particular arrangement of the constituents of the quantum system. For example, the interaction cut-off distance may be 30% or below of the maximal constituent distance, in particular 20% or below, more particularly 10% or below. If the constituents are arranged in a lattice having an elementary distance (lattice constant), the short-range Hamiltonian may such that no interactions occur between constituents distanced from each other by a distance greater than r times the elementary distance (lattice constant) of the lattice. Therein, r may be from 1 to 5, e.g. r=\sqrt{2}, 2, 3, 4 or 5.

More generally, as described in PCT/EP2020/069416, a mesh can be specified to express physical properties of the quantum system, in particular expressing a notion of closeness (short-range property). The mesh can be represented by vertices and cells. The vertices of the mesh represent possible sites for the constituents of the quantum system. Each cell of the mesh is a set of vertices and indicates that (joint) quantum interactions between constituents of the quantum system arranged in that cell are possible during the quantum computation. The mesh and particularly its cells can reflect what is close or short-ranged in the quantum system. A short-range Hamiltonian may be composed of constraint Hamiltonians each of which acts on constituents within a cell. The vertex number (v_{c}) of a cell (c) of the mesh is the number of vertices contained in that cell. The maximal vertex number (vₘₐₓ) of the cells of the mesh is the maximum of the vertex numbers of the cells of the mesh

$$( {v}_{m ax} = {max}_{c} {v}_{c} ) .$$

The maximal vertex number by be equal to the number d, or d is at least not greater than vₘₐₓ.

The short-range Hamiltonian H_{S} may be a sum of constraint Hamiltonians, where each constraint Hamiltonian acts on constituents of the quantum system belonging to a vertex set vs within a cell c of the mesh. The short-range Hamiltonian may have the form H_{S}=Σ_{vs∈VS}S_{VS}⊗_{v∈vs}\tilde{σ}_{z}^{(v)}, where ⊗_{v∈vs}\tilde{σ}_{z}^{(v)}=\tilde{σ}_{z}^{(v}^{₁}⁾ . . . \tilde{σ}_{z}^{(v}^{_{|vs|}}⁾, and vs has the form vs={v₁, . . . , v_{|vs|}} for all vs∈VS, with VS being the set of all vertex sets, and |vs| is the cardinality of the set vs. Further, Sᵥₛ are coefficients, which may be dependent on time (Sᵥₛ=Sᵥₛ(t)), wherein the time-dependent part may be independent of vs, i.e., Sᵥₛ=C(t)Cᵥₛ for all v∈vs. Also, the absolute value of Cᵥₛ may be independent of vs, so either Cᵥₛ=C₀ or Cᵥₛ=−C₀.

Herein, specific forms of the short-range Hamiltonian have been provided by way of example, wherein the short-range Hamiltonian employed Pauli operators \tilde{σ}_{z}. It shall be understood again that this choice is without loss of generality in that corresponding orientations (x, y, z) can be chosen freely, or else the types of Pauli operators can be permuted. The type of the Pauli operators employed for the short-range Hamiltonian can be the same as the type of the Pauli operators employed for the problem Hamiltonian.

### Initial State and Initial Hamiltonian

The method includes initializing the constituents of the quantum system in an initial state. A state of a quantum system is a quantum state, but for simplicity “initial state”, “finale state”, “intermediate state” etc. is used instead of “initial quantum state”, “final quantum state”, “intermediate quantum state” etc. In the method, initializing the constituents of the quantum system in the initial state may include preparing the constituents of the quantum system in the initial state. Preparing the constituents of the quantum system in the initial state may include acting by a local field on the constituents of the quantum system, such as by a strong magnetic or electric field.

Therein, the initial state may be a quantum state that is an eigenstate of an initial Hamiltonian or an approximation of such an eigenstate. The eigenstate of the initial Hamiltonian may be a ground state of the initial Hamiltonian. Preparing the constituents of the quantum system in the initial state may include driving the constituents of the quantum system towards the eigenstate of the initial Hamiltonian, e.g., by cooling.

The initial Hamiltonian, Hᵢₙᵢₜ, may be a single-body Hamiltonian that may include, or consist of, a first sum of first summand Hamiltonians and a second sum of second summand Hamiltonians. The first summand Hamiltonians may act on the first part of the constituents of the quantum system. Each summand Hamiltonian of the first summand Hamiltonians may be represented by a coefficient multiplied with a single-body operator, particularly a Pauli operator, such as a Pauli \tilde{σ}_{z} operator, and may have the form cᵢ\tilde{σ}_{z}⁽ⁱ⁾, with i∈[SC]. The first sum of the first summand Hamiltonians may have the form H_{init,1}=Σ_{i∈[SC]}cᵢ\tilde{σ}_{z}⁽ⁱ⁾. The coefficients cᵢ of the first summand Hamiltonians can be compatible with the side condition or the side conditions associated with the computational problem. This compatibility is understood as follows. Any side condition of the computational problem can be mapped to a side condition of the spin model of the form Σᵢ\tilde{σ}_{z}⁽ⁱ⁾+Σ_{i<j}\tilde{σ}_{z}⁽ⁱ⁾\tilde{σ}_{z}^{(j)}+Σ_{i<j<k}\tilde{σ}_{z}⁽ⁱ⁾\tilde{σ}_{z}^{(j)}\tilde{σ}_{z}^{(k)}+Σ_{i<j<k<l}\tilde{σ}_{z}⁽ⁱ⁾\tilde{σ}_{z}^{(j)}\tilde{σ}_{z}^{(k)}\tilde{σ}_{z}^{(l)}+ . . . cᵣ, as described herein. This implies Σ_{i∈[SC}_{ᵣ}_{]}\tilde{σ}_{z}⁽ⁱ⁾=cᵣ according to the mapping described herein. Compatibility to the r-th side condition is then given if Σ_{i∈[SC}_{ᵣ}_{]}cᵢ=−cᵣ. The second summand Hamiltonians may act on the second part of the constituents of the quantum system. Each summand Hamiltonian of the second summand Hamiltonians may be represented by a coefficient multiplied with a Pauli \tilde{σ}_{z} operator, and may have the form εᵢ\tilde{σ}_{z}⁽ⁱ⁾, with i∈[UC]. The coefficients εᵢ may be randomly chosen. The coefficients εᵢ may have the values +1 or −1. The second sum of second summand Hamiltonians may have the form H_{init,2}=Σ_{i∈[UC]}εᵢ\tilde{σ}_{z}⁽ⁱ⁾. The initial Hamiltonian may therefore have the form Hᵢₙᵢₜ=Σ_{i∈[SC]}cᵢ\tilde{σ}_{z}⁽ⁱ⁾+Σ_{i∈[UC]}εᵢ\tilde{σ}_{z}⁽ⁱ⁾.

Herein, specific forms of the initial Hamiltonian have been provided by way of example, wherein the initial Hamiltonian employs Pauli operators dz. It shall be understood again that this choice is without loss of generality in that corresponding orientations (x, y, z) can be chosen freely, or else the types of Pauli operators can be permuted. The type of the Pauli operators employed for the initial Hamiltonian can be the same as the type of the Pauli operators employed for the problem Hamiltonian.

The initial state, particularly the choice of the quantum state of the constituents of the first part of constituents of the quantum system, may provide that the side condition(s) of the computational problem are initially fulfilled, i.e., at the beginning of the quantum computation. The side condition(s) of the computational problem may be encoded in the initial state. The method may include mapping the side condition or the side conditions associated with the computational problem jointly to the initial state and to the exchange Hamiltonian.

### Quantum Computation

The method of performing a quantum computation on a quantum system includes initializing the constituents of the quantum system in an initial state, evolving the quantum system, and measuring at least a portion of the constituents of the quantum system to obtain a read-out. The evolution of the quantum system may be from the initial state to a final state. The measurement may be made on the at least a portion of the constituents when the quantum system is in the final state. An apparatus for performing the quantum computation may include a quantum processing unit (QPU) for initializing the quantum system in the initial state and/or for controlling the evolution of the quantum system. The apparatus may include a measurement unit for performing measurements of the quantum system.

The evolution of the quantum system may be in accordance with a final Hamiltonian, the exchange Hamiltonian, and the driver Hamiltonian. The final Hamiltonian is the sum of the problem Hamiltonian and of the short-range Hamiltonian. The quantum system may be evolved by interactions of the constituents of the quantum system. The interactions of the constituents may include quantum interactions and/or classical interactions. The interactions of the constituents may include quantum interactions between the constituents. The interactions of the constituents may include classical or quantum interactions with the constituents, e.g., interaction(s) of one or more external fields with the constituents. The interactions of the constituents may include both classical or quantum interactions with the constituents and quantum interactions between the constituents, e.g., an externally induced or moderated quantum interaction between the constituents. The interactions include, or consist of, interactions determined by the final Hamiltonian, interactions determined by the exchange Hamiltonian, and interactions determined by the driver Hamiltonian. This shall include interactions determined by any subset of said Hamiltonians and interactions determined by all of said Hamiltonians.

The evolution of the quantum system during the quantum computation may be controlled by analog driving, in particular by an adiabatic sweep (quantum annealing). Background on adiabatic driving (quantum annealing) is described in EP 3 113 084 B1. Analog driving may alternatively be counter-diabatic driving using a Hamiltonian with an additional counter-diabatic part, with background on this technique being described in WO 2020/259813 A1. The documents EP 3 113 084 B1 and WO 2020/259813 A1 are incorporated by reference.

Evolving the quantum system by interactions of the constituents of the quantum system may include passing from the initial Hamiltonian of the quantum system to the final Hamiltonian via an intermediate Hamiltonian. The intermediate Hamiltonian may include a linear combination of the initial Hamiltonian, the final Hamiltonian, the exchange Hamiltonian, and the driver Hamiltonian. The evolution may be controlled by analog driving, particularly by quantum annealing, or else by counter-diabatic driving. The coefficients of the linear combination of said Hamiltonians may be time-dependent functions. Each time-dependent function may describe the strength of the respective Hamiltonian. The time-dependent functions may describe the relative strength of said Hamiltonians over time. Evolving the quantum system may include adiabatically evolving the initial Hamiltonian into the final Hamiltonian while transiently fading in and then out the driver Hamiltonian and the exchange Hamiltonian. Evolving the initial Hamiltonian into the final Hamiltonian may include fading out the initial Hamiltonian and fading in the final Hamiltonian. Fading out may involve tuning the strength of a corresponding Hamiltonian down, described by a time-dependent function decreasing over time. Conversely, fading in may involve tuning the strength of a corresponding Hamiltonian up, described by a time-dependent function increasing over time. Evolving the quantum system may include quadratically fading out the initial Hamiltonian and linearly fading in the final Hamiltonian. Therein, quadratically fading out (in) means that the decrease (increase) of the strength of the corresponding Hamiltonian is by a quadratic time-dependent function, and linearly fading in (out) means that the increase (decrease) of the strength of the corresponding Hamiltonian is by a linear time-dependent function.

The intermediate Hamiltonian may have the form Hᵢₙₜₑᵣ(t)=I(t)Hᵢₙᵢₜ+D(t)H_{drive}+E(t)H_{exchange}+F(t)H_{final}, wherein H_{final}(t)=p(t)H_{prob}+s(t)H_{S}. Let t₀=0 be an initial time, i.e., a starting point of the quantum computation, and let t_{final} be a final time, i.e., and endpoint of the quantum computation. Then, the following may hold with respect to the functions I, D, E, F, p, and s: I(0)=1, I(t_{final})=0, D(0)=E(0)=0, D(t_{final})=E(t_{final})=0, F(0)=0, F(t_{final})=1, and for all t with t₀=0<t<t_{final} the functions I, D, E, F, p, and s are finite (non-vanishing). The functions p and s are also finite for t=0 and t=t_{final}. So, Hᵢₙₜₑᵣ(0)=Hᵢₙᵢₜ and Hᵢₙₜₑᵣ(t_{final})=H_{final}. Further, p and s may be constant, and specifically p=s=1 may hold, so H_{final} may be regular sum of the problem Hamiltonian and of the short-range Hamiltonian instead of a weighted, potentially time-dependent sum of these two Hamiltonians. When a sum of the problem Hamiltonian and of the short-range Hamiltonian is referred to herein, this shall include a regular, a weighted and a time-dependent weighted sum of the problem Hamiltonian and of the short-range Hamiltonian. The sum of the problem Hamiltonian and of the short-range Hamiltonian may particularly be a regular sum of the problem Hamiltonian and of the short-range Hamiltonian. Also, the choice D=E may be made for simpler driving. The function I may be quadratically decreasing for better fidelity, because this protocol avoids a first order phase transition which is present in the linear case, e.g., I(t)=(1−t/t_{final})². The function F may be linearly increasing, e.g., F(t)=t/t_{final}. An exemplary intermediate Hamiltonian may be given by

$${H}_{i n t e r} ( t ) = {( 1 - \frac{t}{{t}_{final}} )}^{2} {H}_{i n i t} + Γ \frac{t}{{t}_{final}} ( 1 - \frac{t}{{t}_{final}} ) ( {H}_{d r i v e} + {H}_{e x c h a n g e} ) + \frac{t}{{t}_{final}} {H}_{final} ,$$

wherein Γ is a parameter specifying a strength of the drive Hamiltonian and of the exchange Hamiltonian relative to the initial Hamiltonian and final Hamiltonian, wherein the final Hamiltonian is H_{final}=H_{prob}+H_{S}. An intermediate Hamiltonian for a counter-diabatic driving would have an additional counter-diabatic driving term.

The intermediate Hamiltonian may have a degenerate ground state at least at one time during the evolution of the quantum system, e.g., at some time t_{d} with t₀=0<t_{d}<t_{final}. The intermediate Hamiltonian may have a non-degenerate ground state in a time interval after the time t_{d}, e.g. in a time interval [t_{d}, t_{d}+T] for some T. Therein, T may be such that there is no further time at which the intermediate Hamiltonian has a degenerate ground state until the end of the quantum computation at the time t_{final}, but there may alternatively be a further time or further times at which the intermediate Hamiltonian has a degenerate ground state. Such a degeneracy of the ground state of the intermediate Hamiltonian would constitute an error in known methods using adiabatic driving of a quantum computation because the adiabatic theorem hinges on the presence of a permanent energy gap between the ground state and excited states of the intermediate Hamiltonian during the adiabatic sweep. But in the method described herein, such a degeneracy does not imply an error, but can be a desired feature. The reason is that the evolution of the quantum system in accordance with the initial, final, driver and exchange Hamiltonians, and in particular the dynamics induced by the exchange Hamiltonian, can force the state of the quantum system to be in one of the non-degenerate eigenstates after the degeneracy occurred, so there is no ambiguity arising from passing such a degenerate state. When the quantum system is driven to an excited state of the intermediate Hamiltonian, there may be crossings of energy levels as well. Again, the dynamics will select the eigenstate of the intermediate Hamiltonian that the quantum system assumes at the crossing and the energy level and momentary eigenstates that it will follow thereafter. At the final time t_{final}, the intermediate Hamiltonian is identical to the final Hamiltonian, and the state of the quantum system at the final time may be an eigenstate of the final Hamiltonian that is not the ground state of the final Hamiltonian, but some excited state. Such features (degenerate ground state, final state not being a ground state) are not known from common adiabatic quantum computation (quantum annealing).

Accordingly, in the method described herein, the initial state, particularly a state of the first part of the constituents of the quantum system, and the dynamics of the evolution of the quantum system may enforce fulfillment of the side condition or of the side conditions associated with the computational problem during the quantum computation. A lowest energy of the quantum system may be determined which results from an eigenstate or approximate eigenstate of the final Hamiltonian that is compatible with the dynamics. Evolving the quantum system by interactions of the constituents of the quantum system may include evolving a quantum state of the constituents of the quantum system from the initial state towards the final state, wherein the final state may be an eigenstate of the final Hamiltonian, wherein the eigenstate of the final Hamiltonian may be an excited state.

The final state of the quantum system may be the state at time t_{final} resulting from the above evolution of the quantum system. The measurement may be made on at least a portion of the constituents when the quantum system is in this final state. Measurements may be made by a measurement unit of an apparatus for performing the quantum computation. The measurement results may constitute a read-out of the quantum system. A solution to the computational problem may be determined from the read-out, such as by classical computing. The solution may be determined by one or more classical computing systems.

The method of quantum computation described herein differs from known methods such as the method described in EP 3 113 084 B1. The method distinguishes between constituents which are affected by side condition(s) of the computational problem (first part of the constituents), and those which are not (second part of the constituents). The initial state is prepared so that it respects the side condition(s) of the computational problem, i.e., which is compatible therewith as described herein. Therein, the state of the constituents of the first part of constituents is prepared to be compatible with the side condition(s). Further, the dynamics which the constituents undergo conserves the compatibility with the side condition(s). The exchange Hamiltonian is such that the dynamics it introduces leads to states of the first part of constituents that are compatible with the side condition(s) if the initial state was compatible therewith. When the energy is minimized, such as in the process of an adiabatic sweep, then the result need not be the ground state of the final Hamiltonian. The result will be an eigenstate with lowest energy that is compatible with the dynamics (or an approximation thereof). This eigenstate can be an excited state of the final Hamiltonian, i.e., an eigenstate different from the ground state. Since the dynamics respect/enforce the side condition(s) the quantum computation represents an energy minimization respecting the side condition(s) of the underlying computational problem encoded in the problem Hamiltonian. The solution that can be derived from the read out at the end of the quantum computation will be a solution of the computational problem under its side condition(s).

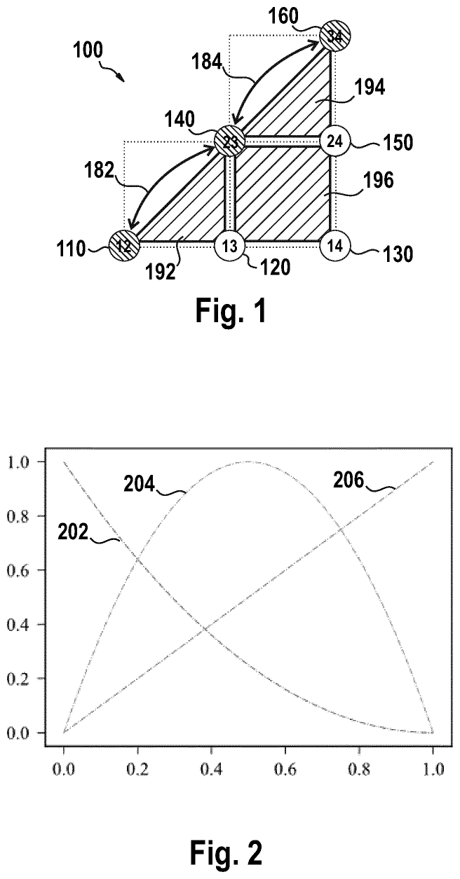

An illustrative example is described with respect to FIGS. 1-4. In the example, a computational problem has been mapped to the spin model Hamiltonian H(σ_{z}⁽¹⁾, . . . , σ_{z}⁽⁶⁾)=Σ_{i<j}⁶Jᵢⱼσ_{z}⁽ⁱ⁾σ_{z}^{(j)}=J₁₂σ_{z}⁽¹⁾σ_{z}⁽²⁾+J₁₃σ_{z}⁽¹⁾σ_{z}⁽³⁾+J₁₄σ_{z}⁽¹⁾σ_{z}⁽⁴⁾+J₂₃σ_{z}⁽²⁾σ_{z}⁽³⁾+J₂₄σ_{z}⁽²⁾σ_{z}⁽⁴⁾+J₃₄σ_{z}⁽³⁾σ_{z}⁽⁴⁾, subject to the side condition σ_{z}⁽¹⁾σ_{z}⁽²⁾+σ_{z}⁽²⁾σ_{z}⁽³⁾+σ_{z}⁽³⁾σ_{z}⁽⁴⁾=1. With an index set [A]={12, 13,14, 23,24, 34} to uniquely index the constituents of the quantum system 100, the spatial arrangement of the constituents may be as shown in FIG. 1, where each of the circles labeled with the indices of the index set [A] represents a constituent 110, 120, 130, 140, 150, and 160, wherein each constituent may particularly be a qubit. The problem Hamiltonian is H_{prob}=Σ_{i∈[A]}Pᵢ\tilde{σ}_{z}⁽ⁱ⁾=P₁₂\tilde{σ}_{z}⁽¹²⁾+P₁₃\tilde{σ}_{z}⁽¹³⁾+P₁₄\tilde{σ}_{z}⁽¹⁴⁾+P₂₃\tilde{σ}_{z}⁽²³⁾+P₂₄\tilde{σ}_{z}⁽²⁴⁾+P₃₄\tilde{σ}_{z}⁽³⁴⁾, with P₁₂=J₁₂, . . . , P₃₄=J₃₄. The side condition translates to \tilde{σ}_{z}⁽¹²⁾+\tilde{σ}_{z}⁽²³⁾+\tilde{σ}_{z}⁽³⁴⁾=1. The constituents affected by the side condition are the constituents indexed as 12, 23, and 34, which form the first part of the constituents of the quantum system, and so [SC]={12, 23, 34}. In FIG. 1, the constituents 110, 140 and 160 with labels 12, 23, and 34 are shown as hatched circles to indicate that they belong to the first part of the constituents. The exchange Hamiltonian is H_{exchange}=Σ_{<i,j>,i,j∈[SC]}+\tilde{σ}₊⁽ⁱ⁾\tilde{σ}₋^{(j)}+\tilde{σ}₋⁽ⁱ⁾\tilde{σ}₊^{(j)}=(\tilde{σ}₊⁽¹²⁾\tilde{σ}₋⁽²³⁾+\tilde{σ}₋⁽¹²⁾\tilde{σ}₊⁽²³⁾)+(\tilde{σ}₊⁽²³⁾\tilde{σ}₋⁽³⁴⁾+\tilde{σ}₋⁽²³⁾\tilde{σ}₊⁽³⁴⁾). The two first order hopping terms are illustrated with arrows 182 and 184 in FIG. 1. The constituents not affected by the side condition are the constituents indexed as 13, 14, and 24, which form the second part of the constituents of the quantum system, and so [UC]=[A]\[SC]={13, 14, 24}. In FIG. 1, the constituents 120, 130 and 150 with labels 13, 14, and 24 are shown as empty circles to indicate that they belong to the second part of the constituents. The driver Hamiltonian is H_{drive}=Σ_{i∈[UC]}\tilde{σ}ₓ⁽¹³⁾+\tilde{σ}ₓ⁽¹⁴⁾+\tilde{σ}ₓ⁽²⁴⁾. The set VS is the set of vertex sets vs, wherein each vertex set contains vertices lying within a cell of a mesh (indicated by dotted lines in FIG. 1). The set VS of vertex sets is VS={{12, 13, 23},{23, 24, 34},{13, 14, 23, 24}}. The short-range Hamiltonian, as a sum of constraint Hamiltonians (“plaquette Hamiltonian”) with constant weights Sᵥₛ=C₀, is H_{S}=Σ_{vs∈VS}Sᵥₛ⊗_{v∈vs}\tilde{σ}ₓ^{(v)}=C₀(\tilde{σ}_{z}⁽¹²⁾\tilde{σ}_{z}⁽¹³⁾\tilde{σ}_{z}⁽²³⁾+\tilde{σ}_{z}⁽²³⁾\tilde{σ}_{z}⁽²⁴⁾\tilde{σ}_{z}⁽³⁴⁾+\tilde{σ}_{z}⁽¹³⁾\tilde{σ}_{z}⁽¹⁴⁾\tilde{σ}_{z}⁽²³⁾\tilde{σ}_{z}⁽²⁴⁾) where C₀=2. The three constraint Hamiltonians are illustrated by the plaquettes 192 and 194 (triangles) and by the plaquette 196 (square) in FIG. 1. The initial state is the ground state of the initial Hamiltonian Hᵢₙᵢₜ=Σ_{i∈[SC]}cᵢ\tilde{σ}_{z}⁽ⁱ⁾+Σ_{i∈[UC]}εᵢ\tilde{σ}_{z}⁽ⁱ⁾=c₁₂\tilde{σ}_{z}⁽¹²⁾+c₂₃\tilde{σ}_{z}⁽²³⁾+c₃₄\tilde{σ}_{z}⁽³⁴⁾+ε₁₃\tilde{σ}_{z}⁽¹³⁾+ε₁₄\tilde{σ}ₓ⁽¹⁴⁾+ε₂₄\tilde{σ}ₓ⁽²⁴⁾, wherein c₁₂, c₂₃, c₃₄ are chosen such that c₁₂+c₂₃+c₃₄=−1, e.g., c₁₂=−1, c₂₃=−1, c₃₄=1, and ε₁₃, ε₁₄, ε₂₄ are randomly chosen as +1 or −1. The initial state, and particularly the state of the constituents 12, 13, 14 of the first part of constituents, is compatible with the side condition.

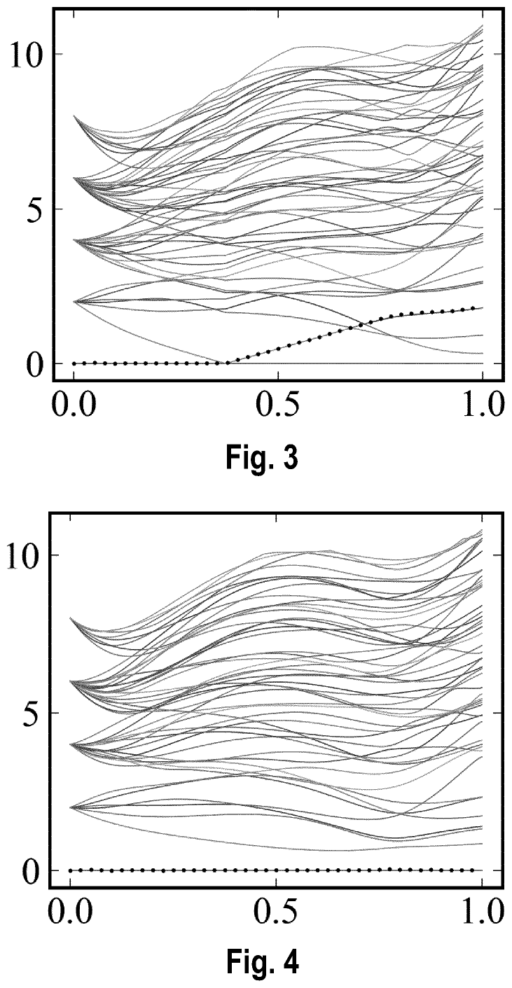

The evolution of the quantum system 100 is controlled by an adiabatic sweep from a starting time t₀=0 to a final time t_{final}, in accordance with the Hamiltonian

$${H}_{i n t e r} ( t ) = {( 1 - \frac{t}{{t}_{final}} )}^{2} {H}_{i n i t} + Γ \frac{t}{{t}_{final}} ( 1 - \frac{t}{{t}_{final}} ) ( {H}_{d r i v e} + {H}_{e x c h a n g e} ) + \frac{t}{{t}_{final}} {H}_{final} ,$$

wherein H_{final}=H_{prob}+H_{S}. Therein, Γ=4 is chosen, and FIG. 2 illustrates the three functions determining the strengths of the three Hamiltonians during the adiabatic sweep as a function of t/t_{final}, namely the function 202 of the strength of the initial Hamiltonian, the function 204 of the strength of the sum of the drive Hamiltonian and of the exchange Hamiltonian, and function 206 the strength of the final Hamiltonian. FIGS. 3 and 4 show the energies (energy eigenvalues) of the momentary eigenstates of Hᵢₙₜₑᵣ(t) as a function of t/t_{final}. The dotted lines in FIGS. 3 and 4 indicate the energies of the quantum states of the quantum system during the adiabatic sweep. In FIG. 3, the coefficients of Jᵢⱼ of the spin model, or equivalently the coefficients Pᵢ of the problem Hamiltonian are P₁₂=−0.8, P₁₃=0.56, P₁₄=0.2, P₂₃=−0.6, P₂₄=−0.667, P₃₄=−0.7. In FIG. 4, the coefficients of Jᵢⱼ of the spin model, or equivalently the coefficients Pᵢ of the problem Hamiltonian are P₁₂=−0.8, P₁₃=0.56, P₁₄=0.2, P₂₃=−0.6, P₂₄=−0.667, P₃₄=0.7.

In FIG. 3, there is a degeneracy of the ground state of the intermediate Hamiltonian at an intermediate time during the adiabatic sweep. The dynamics induced by the quantum computation and particularly by the exchange Hamiltonian conserves the compatibility with the side condition of the computational problem that the initial state exhibits. This property of conserving compatibility with the side condition allows the quantum system to relax within the set of all quantum states compatible with the side condition, but can hinder the quantum system to relax to the ground state of the intermediate Hamiltonian if that ground state is not compatible with the side condition. As shown in FIG. 3, starting at the intermediate time where the degeneracy occurs, the quantum state is driven into an excited state that is compatible with the side condition. Moreover, that excited state experiences a level crossing of the eigenenergies with a second excited state later on, and the quantum system switches to this second excited state at the level crossing, driven by the dynamics of the quantum computation. Again later on, at another level crossing of eigenenergies of the second excited state and of a third excited state, the quantum system switches to the third excited state. So, the quantum system eventually ends up in the third excited state of the intermediate Hamiltonian, which, at time t=t_{final}, is the third excited state of the final Hamiltonian. The solution to the computational problem with side condition is contained in the final state, which is here the third excited state of the final Hamiltonian. The solution of the computational problem with side condition, which can be computed from a read-out (measurement) of the quantum system in its final state at the final time, is therefore different from the solution of the same computational problem without side condition. This is because the latter solution would be contained in the ground state of the final Hamiltonian.

In FIG. 4, no degeneracy of the ground state of the intermediate Hamiltonian occurs. Therefore, there is always an energy gap, and, by the adiabatic theorem, the quantum system remains in the ground state of the intermediate Hamiltonian at all times, meaning that the final state at the final time is the ground state of the final Hamiltonian. In this case, the solution of the computational problem with side condition is the same as the solution of that computational problem without side condition. This shows that it depends on the specific computational problem whether or not a side condition forces the solution to deviate from the solution of the same computational problem in the absence of a side condition. The method of quantum computing described herein works in all such cases without requiring any modifications.

The evolution of the quantum system during the quantum computation may be controlled by digital driving, particularly by gate-based quantum computation. In gate-based quantum computing the quantum computation is driven by applying sequences of unitary operators on an initial state of the quantum system. The sequence of unitary operators and their parameters can be optimized in N rounds of operation by reading out (measuring) the quantum system in at least one previous round and using a classical feed-forward to apply an optimized sequence in a later round. Background on the technique of gate-based quantum computation is described in WO 2020/156680 A1. The document WO 2020/156680 A1 is incorporated by reference.

The aim of the gate-based quantum computation is to first minimize the energy Eₘᵢₙ=min [symbol] ψ|H_{final}|ψ [symbol] in a quantum approximate optimization algorithm (QAOA). Once the minimal (or acceptably low) energy is determined, the constituents are read out by measurement when they are in the quantum state that has the minimal (acceptably low) energy. The read-out contains information about the solution to the computational problem with side condition(s). Therein, the final Hamiltonian may be H_{final}=H_{prob}+H_{S}, and

|ψ [symbol] =U_{H}_{_{drive}}(α₁)U_{H}_{_{exchange}}(β₁)U_{H}_{_{S}}(γ₁)U_{H}_{_{prob}}(δ₁) . . . U_{H}_{_{drive}}(αₘ)U_{H}_{_{exchange}}(βₘ)U_{H}_{_{S}}(γₘ)U_{H}_{_{prob}}(δₘ)|init [symbol] ,

wherein the unitary operators are propagators of the respective Hamiltonians and |init) is an initial state. That means, U_{H}_{_{drive}}(α)=exp(−iαH_{drive}), U_{H}_{_{exchange}}(β)=exp(−iβH_{exchange}), U_{H}_{_{S}}(γ)=exp(−iγH_{S}), and U_{H}_{_{prob}}(δ)=exp(−iδH_{prob}). The minimization is over all parameters α₁ . . . αₘ, β₁ . . . βₘ, γ₁ . . . γₘ, δ₁ . . . δₘ. With disjoint first and second parts of the constituents, H_{drive} and H_{exchange} act on disjoint sets of constituents and therefore commute. Instead of optimizing parameters α₁ . . . αₘ and β₁ . . . βₘ individually for these Hamiltonians, it is also possible to optimize parameters α₁′ . . . αₘ′ of joint unitary operators of the form U_{H}_{_{drive}}_{,H}_{_{exchange}}(α′)=exp(−iα′(H_{drive}+H_{exchange})). Similarly, instead of optimizing parameters γ₁ . . . γₘ and δ₁ . . . δₘ individually for these Hamiltonians, it is also possible to optimize parameters γ₁′ . . . γₘ′ of joint unitary operators of the form U_{H}_{_{S}}_{,H}_{_{prob}}(γ′)=exp(−iγ′(H_{S}+H_{prob}))=U_{H}_{_{final}}(γ′). The optimization of the parameters α₁ . . . αₘ, β₁ . . . βₘ, γ₁ . . . γₘ, δ₁ . . . δₘ for the propagators of the individual Hamiltonians may lead to better approximations in the QAOA, while the optimization of joint parameters for combined propagators may require less rounds of optimization. The initial state |init [symbol] is prepared to be compatible with the side condition or the side conditions of associated with the computational problem in the sense described herein. For instance, the initial state |init [symbol] may be the ground state of the initial Hamiltonian Hᵢₙᵢₜ described herein.

Due to the form of the Hamiltonians, in particular the form of the exchange Hamiltonian, the unitary operators applied in the sequence to evolve the quantum system from the initial state to a final state conserve compatibility with the side condition(s) of the computational problem. If the initial state is compatible with the side condition(s) then so is the final state. Therefore, the minimization of the energy is not over all states, but is by design a minimization over states compatible with the side condition(s). Therefore, when a solution is determined from a read-out of a final state, that solution is a solution to the computational problem with side condition(s). The final state may approximate the ground state of the final Hamiltonian, namely if the ground state is compatible with the side condition(s), but the final state may, for instance, approximate an excited state of the final Hamiltonian, similar as in the example of FIG. 4. The minimization may be done by a variational method, in which the parameters, such as α₁ . . . αₘ, β₁ . . . βₘ, γ₁ . . . γₘ, δ₁ . . . δₘ, are individually varied in different rounds of operation. Comparison of the energies obtained in different rounds of operation allows to select the sequence of unitary operators that led to the lower energy, and to use the selected sequence to further vary the parameters by small perturbations. In this way, the next round of optimization may depend on classical information of a previous round or of previous rounds that is/are fed forward, and the energy is always lowered or at least non-increasing. Details of such a variational method are described in WO 2020/156680 A1. Although the gate-based quantum computation does not involve time as a variable, the application of the sequence of unitary operators is called “dynamics” herein, and the term “propagator” is used as well although the variational parameters take the role of time. The application of the sequence of unitary operators are said to evolve the quantum system according to the dynamics induced by the Hamiltonian(s).

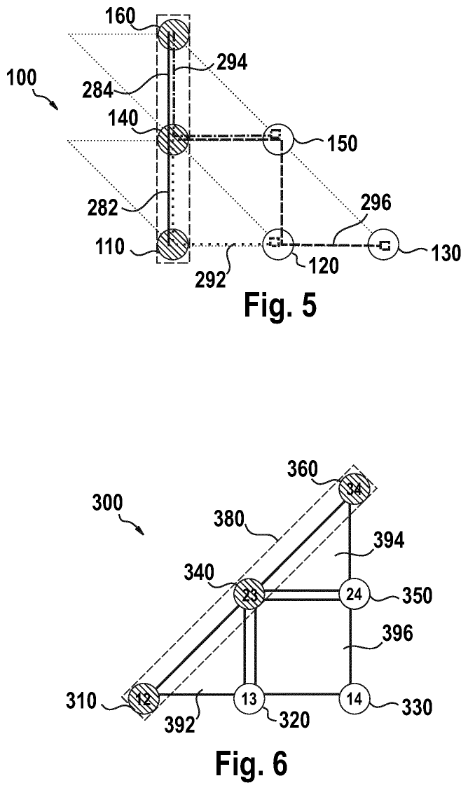

The unitary operators can be implemented by the application of quantum gates acting locally on individual constituents or quantum gates acting on nearest neighbors of constituents. The unitary operators U_{H}_{_{drive}} and U_{H}_{_{prob}} are local, and can be realized by single-qubit rotations and phase rotations. The unitary operator U_{H}_{_{S}}, more specifically the propagators of each of the constraint Hamiltonians, can be realized by CNOT gates and a single-qubit rotations (R_{z}), as described in WO 2020/156680 A1. For instance, FIG. 5 shows the quantum system 100, similar as in the example of FIG. 1, with the same Hamiltonians. FIG. 5 illustrates the realization of the unitary operator U_{H}_{_{S}}. The dashed line 292 indicates that the unitary operator corresponding to the constraint Hamiltonian acting on the constituents 110, 120 and 140 can be realized by a CNOT gate between constituents 140 and 110 (indicated by a dotted line), a CNOT gate between constituents 110 and 120 (indicated by a dotted line), a single-qubit rotation R_{z} on qubit 120 (indicated by the dotted square), and—following the path backward—another CNOT gate between constituents 120 and 110 and another CNOT gate between constituents 110 and 140. Similarly, the dashed-dotted line 294 indicates that the unitary operator corresponding to the constraint Hamiltonian acting on the constituents 140, 150 and 160 can be realized by four CNOT gates and a single-qubit rotation R_{z}, and the dashed line 296 indicates that the unitary operator corresponding to the constraint Hamiltonian acting on the constituents 140, 150, 120 and 130 can be realized by six CNOT gates and a single-qubit rotation R_{z}. The unitary operators U_{H}_{_{exchange}}, more specifically the realization of the propagators of the nearest-neighbor first order hopping terms of the exchange Hamiltonian, can be realized by SWAP gates. The SWAP gate can be implemented with a consecutive application of three CNOT gates (first CNOT gate with qubit 1 being the control and qubit 2 being the target; second CNOT gate with qubit 2 being the control and qubit 1 being the target; third CNOT Gate with qubit 1 being the control and qubit 2 being the target). FIG. 5 illustrates the realization of the unitary operator U_{H}_{_{exchange}}. The solid line 282 indicates a unitary operator corresponding to a nearest-neighbor first order hopping term acting on the constituents 140 and 160, and the solid line 284 indicates a unitary operator corresponding to a nearest-neighbor first order hopping term acting on the constituents 110 and 140, and these unitary operators are realized as described above.

In the method of quantum computation, evolving the quantum system by interactions of the constituents of the quantum system may include determining a sequence of unitary operators. The unitary operators in the sequence may be taken from the following set of unitary operators: a unitary operator being a function of the problem Hamiltonian, a unitary operator being a function of the short-range Hamiltonian, a unitary operator being a function of the driver Hamiltonian, and a unitary operator being a function of the exchange Hamiltonian. The functions may be exponential functions. The unitary operators may be propagators of the problem Hamiltonian, the short-range Hamiltonian, the driver Hamiltonian, and the exchange Hamiltonian, or propagators of the summand Hamiltonians that form said Hamiltonians. The functions may include variational parameters. Each unitary operator in the sequence of unitary operators may come with its own variational parameter.

Evolving the quantum system by interactions of the constituents of the quantum system may include applying the sequence of unitary operators to the quantum system, specifically to the initial state of the quantum system. The initial state may be compatible with the side condition or the side conditions associated with the computational problem, and may be the ground state of the initial Hamiltonian, as described herein. In applying the sequence of unitary operators, parameters of unitary operators may be in a first configuration. The method may include measuring at least a portion of the constituents of the quantum system after application of the sequence of unitary operators to obtain a first read-out. The method may include deriving a first energy from the first read-out, wherein the first energy may be the energy of the final Hamiltonian in the quantum state resulting from the application of the sequence of unitary operators to the initial state.

The method may include applying a second sequence of unitary operators to the quantum system, specifically to the initial state of the quantum system. In applying the second sequence of unitary operators, the parameters of the unitary operators may be in a second configuration, different from the first configuration. The method may include measuring at least a portion of the constituents of the quantum system after application of the second sequence of unitary operators to obtain a second read-out. The method may include deriving a second energy from the second read-out, wherein the second energy may be the energy of the final Hamiltonian in the quantum state resulting from the application of the second sequence of unitary operators to the initial state. The method may include selecting the first or the second sequence in dependence of the first and second read-outs, particularly selecting the first sequence if the first energy is lower than the second energy, and selecting the second sequence if the second energy is lower than the first energy.

The method may include applying a third sequence of unitary operators to the quantum system, specifically to the initial state of the quantum system. In applying the third sequence of unitary operators, the parameters of the unitary operators may be in a third configuration, wherein the third configuration is a variation of the first configuration if the first sequence was selected and wherein the third configuration is a variation of the second configuration if the second sequence was selected. The method may include N rounds of operations, wherein N≥2, wherein each round of the N rounds of operations includes the application of an i-th sequence of unitary operators with the parameters being in an i-th configuration, and measuring at least a portion of the constituents of the quantum system to obtain an i-th read-out. The method may include deriving an i-th energy from the i-th read-out, wherein the i-th energy may be the energy of the final Hamiltonian in the quantum state resulting from the application of the i-th sequence of unitary operators to the initial state. The i-th configuration of the parameters may be determined based on one or more read-outs (or one or more energies) of the previous round(s) of operation. The i-th configuration may be determined such that the energies of the quantum states corresponding to the selected configurations is decreasing (or at least non-increasing).

The method may include, after an N-th round of operations, applying a final sequence of unitary operators to the quantum system, specifically to the initial state, to evolve the quantum system to a final state. The final sequence may be chosen such that its configuration of the parameters provides the minimum of the N energies determined in the N rounds of operations. The method may include measuring the quantum system, or at least a portion thereof, when the quantum system is in the final state. The method may include computing a solution to the computational problem with side condition(s) from the read-out of this measurement.

### Exemplary Implementations

The quantum system and its constituents (such as qubits) are physical entities, as explained herein. Hereinafter, specific implementations of the quantum system/the constituents and of the interactions involved in the method of quantum computation are described. However, the method can be carried out on any other specific implementation of said physical entities and of their interactions, and the exemplary implementations shall not be considered as limiting.

The constituents may be superconducting qubits, e.g. transmon or flux qubits. A superconducting qubit may include a primary and a secondary superconducting loop.

Superconducting currents propagating clockwise and counter-clockwise, respectively, in the primary superconducting loop can form the quantum basis states |1> and|0> of the superconducting qubit. Further, a magnetic flux bias through the secondary superconducting loop can couple the quantum basis states |0> and |1>.

A single-body Hamiltonian, such as the problem Hamiltonian or the initial Hamiltonian, can be realized by a plurality of magnetic fluxes interacting with the superconducting qubits. A magnetic flux or magnetic flux bias may extend through the primary superconducting loop and through the secondary superconducting loop of a superconducting qubit. The parameters of the problem Hamiltonian can be adjusted by adjusting the plurality of magnetic fluxes or magnetic flux biases. Alternatively, a single-body Hamiltonian can be realized by a plurality of charges interacting with the plurality of superconducting qubits. The parameters of the problem Hamiltonian can be adjusted by adjusting a plurality of charge bias fields.

An exchange interaction between transmon superconducting qubits for realizing the exchange Hamiltonian can be implemented via coupling with an intermediate capacity between two Cooper-pair box qubits. In transmons, the qubits are encoded in the charge base and capacitive coupling induces an effective exchange interaction.

For realizing the driver Hamiltonian, a magnetic flux bias through the primary superconducting loop of the superconducting qubit may be set such that the basis states |0> and |1> have the same energy, i.e. the energy difference for these basis states is zero. Further, a magnetic flux bias through the secondary superconducting loop can couple the basis states |0> and |1>. Accordingly, a summand Hamiltonian of the driver Hamiltonian of the form hσₓ^{(k)}, and therefore also the driver Hamiltonian of the form H_{drive}=h Σₖ σₓ^{(k)} can be realized for a superconducting qubit, can be realized for a plurality of superconducting qubits.

A constraint Hamiltonian as a summand Hamiltonian of the short-range Hamiltonian, can be realized using a plurality of ancillary qubits, wherein an ancillary qubit may be arranged inside each (first) cell of the mesh (“plaquette”), e.g., at the center of each (first) cell. Interactions between qubits of the form cₖₘσ_{z}^{(k)}σ_{z}^{(m)} can be realized by a coupling unit, e.g. an inductive coupling unit. The coupling unit includes a superconducting quantum interference device. Applying an adjustable magnetic flux bias to the superconducting quantum interference device allows tuning the coefficient cₖₘ. A constraint Hamiltonian of the short-range Hamiltonian can then be realized by C(σ_{z}⁽¹⁾+σ_{z}⁽²⁾+σ_{z}⁽³⁾+σ_{z}⁽⁴⁾−2σ_{z}^{(p)}−1)², which includes only pairwise interactions of the form σ_{z}^{(k)}σ_{z}^{(m)} and single-body σ_{z}^{(l)} terms corresponding to imposed energy differences between the |0> and |1> quantum basis states. Here, σ_{z}^{(p)} represents the ancilla qubit. The short-range Hamiltonian as a sum of the constraint Hamiltonians can thus be realized. For embodiments involving ancillary qubits, a single-body Hamiltonian of the form hΣₚσ_{z}^{(p)} for the plurality of ancillary qubits is added to the initial Hamiltonian. Alternatively, a plaquette Hamiltonian can be realized without ancillary qubits, e.g., using three-island superconducting devices as transmon qubits. By integrating two additional superconducting quantum interference devices in the coupling unit and by coupling four qubits of a (first) cell of the mesh (“plaquette”) capacitively to a coplanar resonator, a constraint Hamiltonian of the form −Cσ_{z}⁽¹⁾σ_{z}⁽²⁾σ_{z}⁽³⁾σ_{z}⁽⁴⁾ can be realized. The coupling coefficient C can be tuned by time-dependent magnetic flux biases through the two additional superconducting quantum interference devices.

For superconducting charge or flux qubits, CNOT operations, and therefore also SWAP operations, can be realized with an additional capacitive element coupled to two qubits. The interaction strength is tuned by magnetic or electric flux applied to the additional element. Alternatively, the two qubits are coupled to two modes of a Josephson ring modulator. Single-body unitary operators exp(itσₓ) or exp(itσ_{z}) can be realized with controlled external magnetic or electric flux. Thus, the unitary operators/propagators of (the summand Hamiltonians of) the problem Hamiltonian, the driver Hamiltonian, and the short-range Hamiltonian, and the exchange Hamiltonian can be realized.

The qubit states |0> and |1> of the superconducting qubits can be measured with high fidelity using a measurement device including a plurality of superconducting quantum interference devices, in particular N hysteretic DC superconducting quantum interference devices and N RF superconducting quantum interference device latches controlled by bias lines, wherein the number of bias lines scales according to √N.

Alternatively, the quantum system may be realized using a system of trapped ions as qubits. In this case, the quantum basis states |0> and |1> of a qubit are formed by two levels of a Zeeman- or hyperfine manifold or across a forbidden optical transition of alkaline earth, or alkaline earth-like positively charged ions, such as Ca40+.

Individual ions can be addressed by spatial separation or separation in energy. The case of spatial separation involves using a laser beam that has passed through and/or has been reflected from an acousto-optical deflector, an acousto-optical modulator, micromirror devices, or the like. The case of separation in energy involves using a magnetic field gradient that changes internal transition frequencies, allowing selection through energy differences, i.e., detunings of the applied fields.

A single-body Hamiltonian, such as the problem Hamiltonian and the driver Hamiltonian, can be realized by laser fields or microwaves that are resonant or off-resonant with the internal transition, or by spatial magnetic field differences.

Exchange interactions between qubits in an ion-based quantum computer to realize the exchange Hamiltonian can be implemented by coupling each qubit, encoded in two different electronic orbitals of an ion (e.g. hyperfine states), to a common vibrational mode.

Interactions between two ions for realizing the short-range Hamiltonian can be transmitted via a phonon bus. To this end, lasers or microwaves can be used which are detuned with respect to the blue-side and/or red-side band transition of the phonons. The strength of the laser and detuning allow an adjustment of the interaction strength. Direct interactions through Rydberg excitations can also be used.

The ions can be initialized (prepared in the initial state) by optical pumping using a laser that deterministically transfers the ions into one the two quantum basis states. Since this process reduces entropy it can be viewed as a cooling on the internal states of the ions.

CNOT operations, and therefore also SWAP operations, between the trapped ions can be realized via a phonon bus, and the interaction strength can be tuned by frequency modulations of the phonon modes. Single-body unitary operators exp(itσₓ) or exp(itσ_{z}) can be realized via controlled magnetic dipole transitions or controlled Raman transitions. Thus, the unitary operators/propagators of (the summand Hamiltonians of) the problem Hamiltonian, the driver Hamiltonian, the exchange Hamiltonian, and the short-range Hamiltonian can be realized.

A measurement of the ion-based quantum system can be performed by fluorescence spectroscopy. Therein, ions are driven on a transition with short lifetime if they are in one of the two spin states. As a result, the ions in the driven state emit many photons, while the other ions remain dark. The emitted photons can be registered by commercial CCD cameras. Measurement in any of the directions on the Bloch sphere is achieved by appropriate single-qubit pulses prior to the fluorescence spectroscopy.

As yet a further alternative, the quantum system may be realized using ultracold atoms, e.g. ultracold neutral Alkali atoms, which are trapped in an optical lattice or large spacing lattices from laser fields. The atoms can be evolved towards a ground state using laser cooling. The quantum basis states of a qubit can be formed by the ground state of an atom and a high-lying Rydberg state. The qubits can be addressed by laser light.

A single-body Hamiltonian, such as the problem Hamiltonian and the driver Hamiltonian, are realized by variation of the detuning of the electronic transition frequency with respect to the laser frequency.

Exchange interactions between qubits realized in neutral atoms are implemented by coupling to a common collective state. The exchange interactions between atoms can be induced when the atoms are excited to Rydberg states, and a dipole-dipole interaction takes place between two such Rydberg atoms. The hopping terms and therefore the exchange Hamiltonian can be implemented in this way.

Interactions for realizing the constraint Hamiltonians between qubits can be controlled by detuning of a laser that excites d atoms. In this case, the Hamiltonian is a d-body Hamiltonian. Constraint Hamiltonians and thus the short-range Hamiltonian may either be implemented from d-body interactions or from ancillary qubits with two-body interactions.

The initial state may be prepared by exciting atoms being in their ground state to a Rydberg state with a large detuning.

CNOT operations, and therefore also SWAP operations, between Rydberg atoms can be implemented by driving atomic transitions with a laser with detuning to highly excited states. Single-body unitary operators exp(itσₓ) or exp(itσ_{z}) can be realized with detuned laser driving of Rydberg transitions. Thus, the unitary operators/propagators of (the summand Hamiltonians of) the problem Hamiltonian, the driver Hamiltonian, the exchange Hamiltonian and also the short-range Hamiltonian can be implemented.

The qubits can be measured by performing a selective sweep of ground state atoms and fluorescence imaging with single site resolutions.

As yet a further alternative, the quantum system may be realized with quantum dots. Quantum dot qubits may be fabricated from GaAs/AlGaAs heterostructures. The qubits are encoded in spin states, which may be prepared by adiabatically tuning the potential from a single well to a double well potential.

A single-body Hamiltonian, such as the problem Hamiltonian and the driver Hamiltonian can be realized with electric fields. In the initial state, each qubit is prepared either in the state |0> or |1>, which is implemented by adiabatically switching from a single well to a double well with a strong additional magnetic field.

The exchange interaction is mediated via spin-orbit coupling which is tuned with additional magnetic fields.

An interaction between two qubits can be regulated by an electric field gradient and a magnetic field. A constraint Hamiltonian may be realized by using an additional ancillary qubit and interactions realized with pulse sequences and magnetic fields acting on all pairs of a (first) cell of the mesh (“plaquette”), including the ancillary qubit. In this way, the short-range Hamiltonian as a sum of constraint Hamiltonians can be implemented.

CNOT operations, and therefore also SWAP operations, between quantum dots can be realized by electric or magnetic field gradients. Single-body unitary operators exp(itσₓ) or exp(itσ_{z}) can be realized with electric pulse sequences and magnetic fields. Thus, the unitary operators/propagators of (the summand Hamiltonians of) the problem Hamiltonian, the driver Hamiltonian, the exchange Hamiltonian and also the short-range Hamiltonian can be implemented.

The quantum dot qubits can be read out from a pulse sequence by rapid adiabatic passage.

As yet a further alternative, the quantum system may be realized with impurities in solid-state crystals, such as NV Centers, which are point defects in diamond crystals. Other impurities might be used, e.g., color centers tied to chromium impurities, rare-earth ions in solid-state crystals, or defect centers in silicon carbide. NV Centers have two unpaired electrons, which provides a spin-1 ground state that allows the identification of two sharp defect levels with large life times that can be used to realize a qubit, possibly in conjunction with the surrounding nuclear spins.

Using magnetic resonance through the application of microwave pulses, qubit states can be coherently manipulated on nano-second timescales. Selective single-qubit manipulation can also be achieved conditional on the state of the close-by nuclear spins.

Exchange interactions between qubits realized in crystal defects (i.e. NV centers and silicon quantum computers) can be mediated via the dipole-dipole interaction of the defect. Qubits are encoded in the spin of a free electron from doping the crystal with a defect. The exchange interaction between qubits for realizing the exchange Hamiltonian can be induced by controlling the dipole-dipole interaction formed by the electron and the crystal.

Interactions between NV centers for realizing the short-range Hamiltonian can be transmitted by coupling the NV centers to light fields.

For a quantum system realized with NV Centers, the NV Centers may be addressed individually by using standard optical confocal microscopy techniques. Initialization (preparation of the initial state) and measurements can be performed by off-resonant or resonant optical excitation.

Single qubit operations are implemented by coupling the nuclear spin to the electronic spin and microwave driving of the electronic spin. Exchange interactions are mediated by the magnetic dipole-dipole interaction of the spin electron. The qubit may be encoded in the nuclear spin of the NV center. Exchange interactions are implemented via coupling of the nuclear spin states to electronic spin states via hyperfine coupling. The electronic spins interact via dipole-dipole interaction. After the interaction between the electronic states, the spin is coupled to the nuclear spin. This implements an effective interaction between the long-lived nuclear spins. SWAP operations are implemented by applying the exchange Hamiltonian for a given time. The CNOT gate is implemented by coupling of the two nuclear spins to two electronic spins and microwave driving of the electronic spins.

### Quantum Operation Control Layout

Herein, a method of performing a quantum computation is described which can provide a solution to a computational problem that is subject to one or more side conditions. It is known that such a computational problem can be mapped to a spin model with spin model Hamiltonian H(σ_{z}⁽¹⁾, . . . σ_{z}^{(N)})=Σᵢ^{N}hᵢσ_{z}⁽ⁱ⁾+Σ_{i<j}^{N}Jᵢⱼσ_{z}⁽ⁱ⁾σ_{z}^{(j)}+Σ_{i<j<k}^{N}Rᵢⱼσ_{z}⁽ⁱ⁾σ_{z}^{(j)}σ_{z}^{(k)}+Σ_{i<j<k<l}Tᵢⱼₖₗσ_{z}⁽ⁱ⁾σ_{z}^{(j)}σ_{z}^{(k)}σ_{z}^{(l)}+ . . . . The side condition(s) of the computational problem may be mapped to side conditions of the spin model under the same mapping (and may be brought into some standard form). Then, there may be r side conditions, with r=1, 2, 3,4, . . . , the r side conditions having the form Σᵢσ_{z}⁽ⁱ⁾+Σ_{i<j}σ_{z}⁽ⁱ⁾σ_{z}^{(j)}+Σ_{i<j<k}σ_{z}⁽ⁱ⁾σ_{z}^{(j)}σ_{z}^{(k)}+Σ_{i<j<k<l}σ_{z}⁽ⁱ⁾σ_{z}^{(j)}σ_{z}^{(k)}σ_{z}^{(l)}+ . . . =cᵣ. The method may encode the spin model or else directly the computational problem) into a single-body problem Hamiltonian acting on the constituents of the quantum system. Therein, each single-body summand Hamiltonian of the problem Hamiltonian may correspond to one of the summands (interaction terms) in the spin model. The r side conditions of the spin model may be mapped to r side conditions of the quantum system by the same mapping. The constraint Hamiltonians, i.e., the summand Hamiltonians of the short-range Hamiltonian, ensure consistency with the spin model by reducing the degrees of freedom of the quantum system that the quantum system has in excess of the degrees of freedom of the spin model.

The constituents of the quantum system may be split into a first part and into a second part in the method described herein, wherein the first part of constituents contains the constituents affected by the r side conditions of the quantum system, and the second part of constituents contain the constituents not affected by the side conditions. The Hamiltonian dynamics, whether in the form of an analog quantum computation (such as adiabatic quantum computation) in real time or in the form of digital quantum computation by the application of quantum gates, is governed by a Hamiltonian that includes the problem Hamiltonian acting on all constituents participating in the quantum computation and that includes the short-range Hamiltonian which acts on constituents both in the first and second parts. At least one constraint Hamiltonian, as a summand Hamiltonian of the short-range Hamiltonian, may act on constituents in both the first and second parts. In contrast, the driver Hamiltonian acts only on constituents of the second part, and the exchange Hamiltonian acts only on constituents of the first part. As described herein, the solution of a computational problem with side condition(s) can be computed by a quantum computation using this design of Hamiltonians that act on constituents of the first part, of the second part, or of both the first and second parts, wherein the dynamics induced by these Hamiltonians maintain compatibility with the r side conditions (i.e., the quantum system stays in a quantum state that is compatible with the r side conditions when it starts in an initial state that is compatible with the r side conditions). Therein, the constraint Hamiltonians of the short-range Hamiltonian are non-local (i.e. they act on more than one constituent), and the hopping terms of the exchange Hamiltonian are non-local.

PCT/EP2020/069416 describes a quantum operation control layout, and methods and systems of determining and using it. The quantum operation control layout can be loaded into a quantum processing unit to control the quantum operations of the quantum computation. The quantum operation control layout can be viewed as a control program for the quantum computation in the method performing a quantum computation. The quantum operation control layout can indicate layout vertices to be occupied by constituents of the quantum system during the quantum computation. The quantum operation control layout further indicates sets of layout vertices indicating interactions to be performed between the layout vertices of each set of layout vertices during the quantum computation (non-local interactions). Specifically, each set of layout vertices may cause the quantum processing unit to let a constraint Hamiltonian act on the constituents that correspond to the layout vertices of that set of layout vertices. Local interactions take place on individual constituents, and are therefore automatically indicated by the layout vertices, particularly because PCT/EP2020/069416 considers only one single-body Hamiltonian, namely the problem Hamiltonian.

The quantum operation control layout can be determined by a mesh mapping. Therein, the spins of the spin model to which the computational problem is mapped may be abstracted to nodes of a hypergraph and the interactions in the spin model may be abstracted to hyperedges of that hypergraph. The mesh mapping is constructed to ensure the consistency between the degrees of freedom of the spin model and of the quantum system whose constituents are to arranged according to the layout vertices of the quantum operation control layout. To this end, a constraining subset of a set of generalized cycles of the hypergraph (or of an enlarged hypergraph) are determined. The generalized cycles of the constraining subset are mapped to the layout vertex sets, wherein the layout vertices of each layout vertex set lie in one cell of the mesh. This mapping provides said consistency of the degrees of freedom of the spin model and of the quantum system. Further, cells of the mesh describe closeness relations between vertices of the mesh, as already described herein. In this way, each constraint Hamiltonian that acts on constituents that correspond to the layout vertices of that set of layout vertices can be realized by (short range) interactions which are possible during the quantum computation. The notions of mesh, vertex, cell, vertex number of a cell, maximal vertex number, node, hyperedge, hypergraph, enlarged hypergraph, generalized cycles (both regular and irregular), constraining subset of generalized cycles, layout vertex, layout vertex set shall be understood as in PCT/EP2020/069416, unless modified herein.

An extension for the quantum operation control layout and the method of determining the quantum operation control layout is provided to deal with the different Hamiltonians and dynamics described herein. The hopping terms of the exchange Hamiltonian imply non-local interactions, as do the constraint Hamiltonians whose form remains unchanged. So that the exchange Hamiltonian can be realized during the quantum computation, some closeness relation may be specified between the constituents on which the exchange Hamiltonian or its summand Hamiltonians act, and this closeness relation may deviate from the closeness relation specified in connection with the constraint Hamiltonians.

The mesh that abstractly describes sites on which constituents can be arranged during the quantum computation, and cells indicating which quantum interactions are possible between constituents during the quantum computation, is now made to include first cells and second cells. The first cells correspond to the cells previously described, and indicate that first quantum interactions are possible during the quantum computation, in particular quantum interactions in accordance with constraint Hamiltonians of the short-range Hamiltonian. The second cells indicate that second quantum interactions are possible during the quantum computation, in particular quantum interactions in accordance with hopping terms of the exchange Hamiltonian. The first cells may be of a first type. The second cells may be of a second type. The first type of cells may be different from the second type of cells. In this way, potentially different closeness relations for realizing different non-local interactions can be described. The types of first and second cells, the shape and/or size of first cells, and the shape and/or size of second cells can depend on the concrete quantum system with which the quantum computation is to be carried out, and therefore the mesh contains information about physical properties of the quantum system. Properties relating to cells of the mesh in PCT/EP2020/069416 transfer to properties of the first cells of the mesh.

As described in PCT/EP2020/069416, the spins and interaction terms of the spin model to which the computation problem can be mapped can be specified as nodes and hyperedges of a hypergraph, respectively. The r side conditions of spin model can be expressed as r fixed hypergraph relations. A hypergraph relation shall be understood as a set of hypergraphs. Each fixed hypergraph relation contains the hyperedges representing the interaction terms of the spin model being subject to a side condition, wherein the term “fixed” expresses the connection to the side condition. For example, consider once again the basic example of the spin model H(σ_{z}⁽¹⁾, . . . , σ_{z}⁽⁶⁾)=Σ_{i<j}⁶Jᵢⱼσ_{z}⁽ⁱ⁾σ_{z}^{(j)}=J₁₂σ_{z}⁽¹⁾σ_{z}⁽²⁾+J₁₃σ_{z}⁽¹⁾σ_{z}⁽³⁾+J₁₄σ_{z}⁽¹⁾σ_{z}⁽⁴⁾+J₂₃σ_{z}⁽²⁾σ_{z}⁽³⁾+J₂₄σ_{z}⁽²⁾σ_{z}⁽⁴⁾+J₃₄σ_{z}⁽³⁾σ_{z}⁽⁴⁾ with the side condition σ_{z}⁽¹⁾σ_{z}⁽²⁾+σ_{z}⁽²⁾σ_{z}⁽³⁾+σ_{z}⁽³⁾σ_{z}⁽⁴⁾=1. The hypergraph representing this spin model is ({1, 2, 3, 4, 5, 6},{{1,2},{1,3},{1,4},{2,3}, {2,4},{3,4}}), the hypergraph being a graph in this example, and the side condition can be represented by the fixed hypergraph relation {{1,2},{2,3},{3,4}} between nodes 1, 2, 3 and 4 of the hypergraph. Further, the coefficients Jᵢⱼ may be stored in the form of weights of the hyperedges (weighted hypergraph). A pair containing the fixed hypergraph relation and the coefficient c, of the side condition (which is 1 in the example here) can be formed to conserve the information about the coefficient cᵣ. Since side conditions on individual spins (nodes of the hypergraph) can be dealt with as described in PCT/EP2020/069416 by irregular generalized cycles, the fixed hypergraph relations may each include at least two hyperedges of the hypergraph.

The hyperedges of the fixed hypergraph relations are mapped to vertices of the mesh, wherein the hyperedges of each fixed hypergraph relation are mapped to one of the second cells of the mesh. The hyperedges of the hypergraph (or of an enlarged hypergraph as described in PCT/EP2020/069416) are mapped to vertices of the mesh, wherein each generalized cycle of the constraining subset of the set of generalized cycles consists of hyperedges mapped to one of the first cells of the mesh. The mesh mapping thus respects both the fixed hyperedge relations imposed by the side conditions and the generalized cycles of the constraining subset which make the quantum system and the spin model consistent. The vertices to which the hyperedges are mapped become the layout vertices of the quantum operation control layout. First layout vertex sets and second layout vertex sets can be contained in the quantum operation control layout, represented by some formatted data. Each first layout vertex set consists of layout vertices within one of the first cells of the mesh, these layout vertices corresponding to a generalized cycle of the constraining subset of generalized cycles. Each second layout vertex set consists of layout vertices within one of the second cells of the mesh, these layout vertices corresponding to a fixed hyperedge relation of the set of one or more fixed hyperedge relations.

FIG. 6 shows a graphical representation of an exemplary quantum operation control layout, continuing the basic example described herein. The quantum operation control layout 300 includes a set of layout vertices {12, 13, 14, 23, 24, 34} shown with reference signs 310, 320, 330, 340, 350, and 360. The quantum operation control layout includes first layout vertex sets {12, 13, 23},{13, 14, 23, 24}, {23,24, 34} that correspond to generalized cycles of a constraining subset (here: regular generalized cycles, such as the regular generalized cycle {{1,2}, {1,3}, {2,3}} in which each node 1, 2, 3 contained as an element in a hyperedge appears an even number of times as an element within all three hyperedges combined). The first layout vertex sets are indicated with solid lines and are given the reference signs 392, 394, and 396. The layout vertices of each first layout vertex set are contained within first cells of the mesh (e.g., rectangular first cells; not shown). The quantum operation control layout includes a second layout vertex set {12, 23, 34} that corresponds to a fixed hyperedge relation associated with a side condition of the spin model/of the computational problem. The second layout vertex set is indicated with dashed lines and is given the reference sign 380. The layout vertices of the second layout vertex set are contained within one of second cells of the mesh (not shown). The second cells are of a different type than the first cells in this example.

When loaded into a quantum processing unit of a quantum computing apparatus, the quantum operation control layout 300 shown in FIG. 6 can cause the quantum processing unit to carry out an analog quantum computation as illustrated in FIG. 1. For example, for analog quantum computation, the quantum operation control layout 300 can cause the quantum processing unit to determine, from the second layout vertex set 380, which layout vertices are contained therein, in this case the layout vertices 310, 340 and 360. Constituents 110, 140 and 160 arranged on the sites of the layout vertices 310, 340 and 360 of the second layout vertex set can form the first part of constituents and can be prepared in a quantum state so that the initial state is compatible with the side condition, and the exchange Hamiltonian may act on these constituents, such as first order hopping terms 182 and 184 of the exchange Hamiltonian. The quantum processing unit may determine all layout vertices, and by subtracting the layout vertices contained in the second layout vertex set 380, derive a layout vertex set of layout vertices 320, 330, and 330. Constituents 120, 130 and 150 arranged on the sites of the layout vertices 320, 330 and 350 can form the second part of constituents, and the driver Hamiltonian may act on these constituents. Further, constraint Hamiltonians 192, 194 and 196 corresponding to the first layout vertex sets 392, 394, and 396 may be applied by the quantum processing unit as the action of the short-range Hamiltonian. The quantum processing unit can apply summand Hamiltonians of the problem Hamiltonian to all constituents 110, 120, 130, 140, 150, and 160 arranged at the sites indicated by the layout vertices 310, 320, 330, 340, 350, and 360 of the quantum operation control layout 300. Similarly, the quantum operation control layout can cause the quantum processing unit to carry out a digital quantum computation as illustrated in FIG. 5.

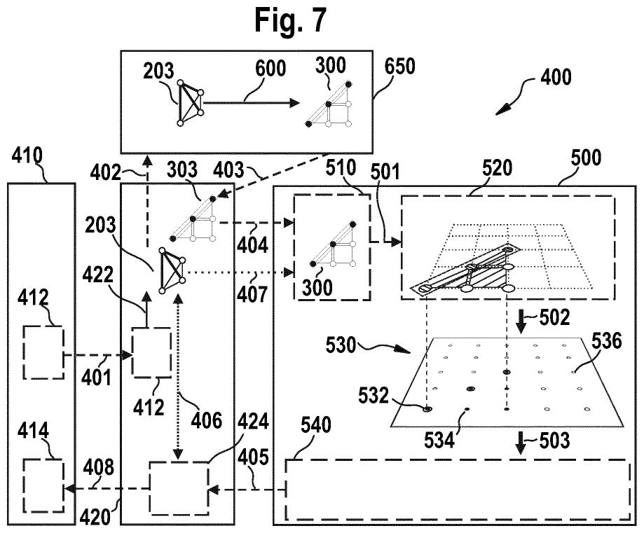

FIG. 7 shows a system 400 for solving a computational problem 412 with a side condition using a quantum computation performed by a quantum computing system 500. In the embodiment shown in FIG. 7, the computational problem 412 is stored in a first classical computing system 410. A classical computing system may refer to a computing system operating on bits or other classical units of information. A classical computing system may include a central processing unit (CPU) for processing information represented by bits and/or a memory for storing information represented by bits. A classical computing system may include one or more conventional computers, such as personal computers (PCs), and/or a network of conventional computers. The first classical computing system 410 sends, 401, the computational problem 412 to a second classical computing system 420. It shall be understood that sending, receiving, encoding, decoding, storing, loading and other conventional tasks are performed on or with data representing the computational problem, the hypergraphs, the quantum operation control layouts etc., or on or with data from which these entities can be derived. For simplicity, the description omits the mentioning of such data, and speaks about “sending the computational problem”, “encoding the hypergraph”, “storing the quantum operation control layout” etc.

The second classical computing system 420 encodes, 422, the computational problem 412 into a hypergraph and associated fixed hyperedge relations. The hypergraph is associated with a corresponding spin model, and the fixed hyperedge relations are associated with side condition(s) of the spin model, so that the solution of finding the lowest energy state compatible with the side condition(s) for the spin model can be transferred back to a solution of the computational problem. In FIG. 7, hypergraph 203 is exemplarily shown as the hypergraph generated by the second classical computing system 420, with one fixed hyperedge relation shown schematically by bold lines. The second computing system 420 sends, 402, the hypergraph to a system 650 for determining a quantum operation control layout for a quantum computation on a quantum system. The system 650 may be a third classical computing system, such as a conventional computer or a network of conventional computers, a computer cluster or network of computer clusters, or a cloud computing environment. The system 650 may be configured for carrying out the method of determining the quantum operation control layout for the quantum computation described herein. In FIG. 7, the system 650 carries out the computer-implemented method 600, and in the depicted example the system 650 is used to determine the quantum operation control layout 300 from the hypergraph 203.

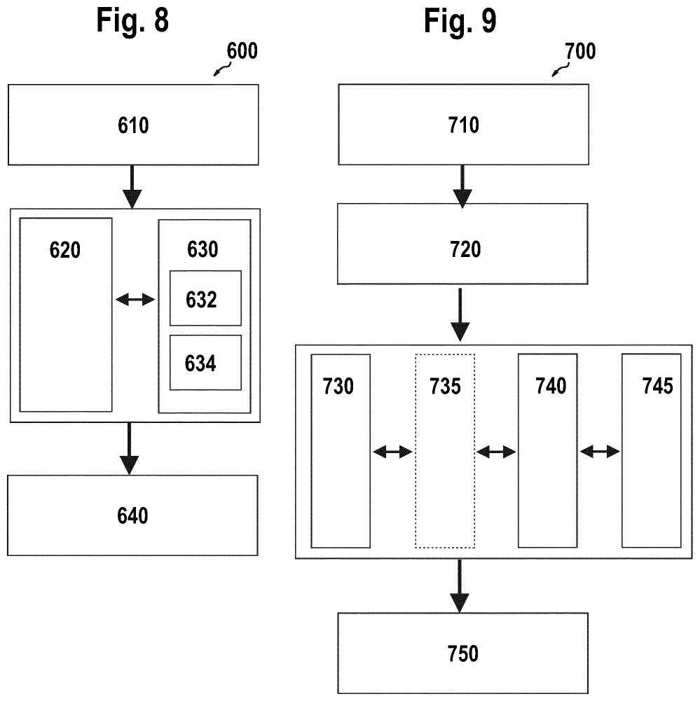

The computer-implemented method 600 is schematically shown in FIG. 8, and includes providing, 610, hyperedges of a hypergraph and at least one fixed hypergraph relation, such as hypergraph 203 with one fixed hypergraph relation. This may include receiving the hypergraph and the fixed hypergraph relation(s) over a network component and/or loading the hypergraph and the fixed hypergraph relation(s) from memory. The method 600 includes determining, 620, by a processor of the system 650, a set of generalized cycles from the hypergraph or from an enlarged hypergraph, while considering properties of the mesh, in particular the maximal vertex number of the first cells of the mesh, as described herein. The method 600 includes determining, 630, by the processor of the system 650, the mesh mapping that maps the hyperedges of the hypergraph (or of the enlarged hypergraph) to the vertices of the mesh. The mesh mapping is such that, 632, each generalized cycle of a constraining subset of the set of generalized cycles consists of hyperedges mapped to one of the first cells of the mesh, and such that, 634, each fixed hyperedge relation of the set of one or more fixed hyperedge relations consists of hyperedges mapped to one of the second cells of the mesh, as described herein. The determination 620 of the generalized cycles may precede the determination 630 of the mesh mapping, but the determination 620 of the generalized cycles and the determination 630 of the mesh mapping, in particular with respect the mapping 632 of the generalized cycles, may be intertwined, and are thus shown next to each other in FIG. 8. The method 600 includes generating, 640, the quantum operation control layout, such as the quantum operation control layout 300, wherein generating is performed by the processor of the system 650. The quantum operation control layout includes layout vertices 310, 320, 330, 340, 350, 360 of the mesh and first layout vertex sets 392, 394, 396, each first layout vertex set consisting of layout vertices within one of the first cells of the mesh that correspond to a generalized cycle of a constraining subset of generalized cycles as determined by the determination 620. The quantum operation control layout includes second layout vertex sets, here one second layout vertex set 380 that corresponds to the fixed hyperedge relation of the hypergraph 203. Herein, “the quantum operation control layout including layout vertices” and the like is to be understood as the quantum operation control layout including data representing the layout vertices etc., but the reference to data and suitable data structures is omitted for simplicity.

The quantum operation control layout determined by the system 650 may be stored in a memory of the system 650. The quantum operation control layout, such as the quantum operation control layout 300 shown in FIG. 6 and FIG. 7, is sent, 403, to the second classical computing system 420. The second classical computing system 420 sends, 404, the quantum operation control layout to the quantum computing system 500. In FIG. 7, the quantum computing system is therefore shown to have received quantum operation control layout 300 in an input section 510.

The quantum operation control layout 300 can control the quantum computation on the quantum computing system 500. A quantum processing unit (QPU) 520 loads, 501, the quantum operation control layout 300 from the input section 510, and controls, 502, local operations on the qubits of the quantum system 530, as well as interactions between the qubits as specified by the quantum operation control layout 300. The qubits are physical two-level quantum systems, and may be realized in specific forms as described herein. In FIG. 7, the qubits are arranged in a lattice, here a square lattice. Qubits such a qubit 532 that belong to the first part of constituents (qubits) of the quantum system 530 are shown with black dots surrounded by a black circle. Qubits such as qubit 534 that belong to the second part of constituents (qubits) of the quantum system 530 are shown with black dots. Other sites of a lattice are shown with circles, such as site 536, and these other sites may either be empty or occupied by qubits not participating in the quantum computation. When the QPU 520 has evolved the quantum system 530 from an initial state to a final state under the control of the quantum operation control layout 300, the qubits of the quantum system 530 or a portion thereof are measured, 503, by a measurement unit 540. Such measurement is also called a readout.

The quantum computing system 500 may perform a method 700 of performing a quantum computation on the quantum system 530 schematically illustrated in FIG. 9. The quantum computation is carried out on the qubits of the quantum system 530. The method 700 includes providing, 710, the quantum operation control layout, which may include loading the quantum operation control layout for executing the control instructions contained therein by the QPU 520. The method 700 includes providing, 720, the qubits of the quantum system in a spatial arrangement, e.g., in a two-dimensional lattice, such that there is a qubit for every layout vertex of the mesh and, for each first layout vertex set from the first layout vertex sets, first quantum interactions (interactions determined by the short-range Hamiltonian) are possible between constituents corresponding to layout vertices of that first layout vertex set, and, for each second layout vertex set from the second layout vertex sets, second quantum interactions (interactions determined by the exchange Hamiltonian) are possible between constituents corresponding to layout vertices of that second layout vertex set. Providing, 720, qubits in the spatial arrangement may include or consist of addressing proper qubits of a set of qubits fixedly arranged in spatial positions, e.g., in a two-dimensional lattice. The method 700 includes applying, 730, for each layout vertex associated with a non-zero weight, a local field (local operation determined by the problem Hamiltonian) to the qubit corresponding to that layout vertex. The method 700 may include applying, 735, for each layout vertex not contained in the second layout vertex sets, a local field (local operation determined by the driver Hamiltonian) to the qubit corresponding to that layout vertex. The qubits to which this local field is applied form the first part of constituents (qubits) of the quantum system. The method 700 includes, performing, 740, for each first layout vertex set, first quantum interactions (non-local operations determined by the short-range Hamiltonian) between qubits corresponding to the layout vertices of that first layout vertex set. The method 700 includes, performing, 745, for each second layout vertex set, second quantum interactions (non-local operations determined by the exchange Hamiltonian) between qubits corresponding to the layout vertices of that second layout vertex set. The applications 730, 735 of local fields and the performance 740, 745 of quantum interactions may be performed by the QPU 520 in a specific way and order in accordance with the type of driving the quantum system from an initial state to a final state (e.g., adiabatic driving, counter-diabatic driving, gate-based quantum interactions). The method 700 includes measuring, 750, some or all of the qubits of the quantum system, using the measurement unit 540. The results of the measurement 750 are the result of the quantum computation.

The measurement results of the quantum computation are sent, 405, to the second classical computing system 420. The second classical computing system 420 includes a verification unit 424 which receives the measurement results, and checks, 406, if the measurement results contain a solution to the problem of finding the lowest energy state of the spin model compatible with the side condition(s) that is associated with the hypergraph 203 (spin model problem). If yes, the verification unit 424 computes a solution to the computational problem 412 with side condition(s) from the solution to the spin model problem, and sends, 408, the solution to the computational problem 412 with side condition(s) to the first classical computing system 410. The first classical computing system receives the solution to the computational problem with side condition(s), the solution to the computational problem with side condition(s) being depicted with reference sign 414 in FIG. 7. If the measurement results did not contain a solution to the spin model problem, the second classical computing system 420 instructs, 407, the quantum processing system 500 to repeat the quantum computation. The quantum computation may be repeated until a solution for the spin model problem, and thus ultimately for the computational problem 412 with side condition(s), is found, or may be repeated a predetermined finite number of times and the best approximate solution is sent to the first classical computing system if no solution is found in the predetermined finite number of iterations.

In the embodiments shown in FIG. 7, including embodiments of a system 400 for determining the solution to a computational problem, embodiments of a system 650 for determining a quantum operation control layout for a quantum computation on a quantum system, and embodiments of a quantum computing system 500 for performing the quantum computation on the quantum system, in particular under the control of the quantum operation control layout, the functions and services have been shown as distributed in a specific way. This shall only be illustrative, and any of the functions of the classical computing systems 410, 420 and/or of the system 650 for determining the quantum operation control layout may be integrated within one of the respective other systems, or within the quantum computing system 500. The functions of the classical computing systems 410, 420, of the system 650, and possibly also of the input section 510, may be regarded as functions of an encoder. The encoder may be configured for encoding the computational problem into a problem Hamiltonian of the constituents of the quantum system. The encoder may be configured for mapping a side condition or side conditions associated with the computational problem to an exchange Hamiltonian of the first part of the constituents of the quantum system. The encoder may be configured to perform any of the other functions of some or all of the classical computing systems 410, 420, the system 650, and the input section 510. Therein, the system 650 and a quantum operation control layout is optional. The encoder may use a quantum operation control layout, or may directly encode the computational problem and the side conditions and determine an appropriate arrangement of the constituents, including forming first and second parts of the constituents.

According to some embodiments, a method of determining a quantum operation control layout for a quantum computation on a quantum system is provided. The method may be a computer-implemented method, and may be implemented on a classical computer, computer-network or cloud-based computing system. The quantum computation is to be carried out on constituents of the quantum system arranged in accordance with a mesh having vertices, first cells and second cells. The vertices of the mesh represent possible sites for the constituents of the quantum system. Each cell of the first cells indicates that first quantum interactions between constituents of the quantum system arranged in that cell are possible during the quantum computation. Each cell of the second cells indicates that second quantum interactions between constituents of the quantum system arranged in that cell are possible during the quantum computation. The first quantum interactions may correspond to the actions of constraint Hamiltonians, as described herein. The second quantum interactions may correspond to the actions of summand Hamiltonians (such as first order hopping terms or sums thereof) of the exchange Hamiltonian, as described herein.

The method includes providing a data set including data representing hyperedges of a hypergraph and including data representing a set of one or more fixed hyperedge relations. A fixed hyperedge relation includes a set of hyperedges of the hypergraph. A fixed hyperedge relation may include a set of at least two hyperedges of the hypergraph. The method includes determining a set of generalized cycles, the generalized cycles containing hyperedges of the hypergraph or containing hyperedges of an enlarged hypergraph, the enlarged hypergraph at least including the hyperedges of the hypergraph and an additional hyperedge. Therein, a maximal length of generalized cycles of the set of generalized cycles is not greater than a maximal vertex number of the first cells of the mesh. The method includes determining a mesh mapping that maps data representing the hyperedges of the hypergraph or of the enlarged hypergraph to the vertices of the mesh, wherein each generalized cycle of a constraining subset of the set of generalized cycles consists of hyperedges mapped to a cell of the first cells of the mesh and wherein each fixed hyperedge relation of the set of one or more fixed hyperedge relations consists of hyperedges mapped to a cell of the second cells of the mesh.

The method includes generating the quantum operation control layout. The quantum operation control layout includes data indicating layout vertices of the mesh. Each layout vertex corresponds to a hyperedge mapped according to the mesh mapping, including data indicating first layout vertex sets, each first layout vertex set consisting of layout vertices within a cell of the first cells of the mesh that correspond to a generalized cycle of the constraining subset of generalized cycles, and including data indicating one or more second layout vertex sets, each second layout vertex set consisting of layout vertices within a cell of the second cells of the mesh that correspond to a fixed hyperedge relation of the set of one or more fixed hyperedge relations. Therein, determining the mesh mapping may include considering each fixed hyperedge relation with priority over any generalized cycle when mapping the data representing the hyperedges of the hypergraph or of the enlarged hypergraph to the vertices of the mesh.

The mesh may be two-dimensional. The lengths of the generalized cycles of the set of generalized cycles may be in the range from two (or three) to the maximal vertex number of the cells of the mesh, or may be equal to the maximal vertex number of the cells of the mesh. The number of nodes of the hypergraph may be N, the number of hyperedges of the hypergraph may be K, and the cardinality of the constraining subset may be at least K−N. The number K of hyperedges of the hypergraph may be smaller than N(N−1)/2. The hyperedges of the hypergraph may be associated with weights. The quantum operation control layout may include data associating the layout vertices with the weights of the hyperedges of the hypergraph or of the enlarged hypergraph that are mapped to the layout vertices by the mesh mapping. Additional hyperedges of the enlarged hypergraph not contained in the hypergraph may be assigned a weight of zero. The quantum operation control layout may be a transparent quantum operation control layout. The union of generalized cycles of the constraining subset of generalized cycles may contain all hyperedges of the hypergraph or of the enlarged hypergraph. The generalized cycles of the constraining subset of generalized cycles may connect all hyperedges of the hypergraph or of the enlarged hypergraph. The cardinality of at least one hyperedge of the hypergraph may be odd. The cardinality of at least one hyperedge of the hypergraph may be at least three. The constraining subset may include at least one of: a regular generalized cycle and an irregular generalized cycle. The mesh mapping may be constructed by mapping the hyperedges of a first fixed hyperedge relation on vertices of one of the second cells of the mesh. The construction may include mapping the hyperedges of a second fixed hyperedge relation on vertices another one of the second cells of the mesh. The construction may include doing the same for a third, fourth etc. fixed hyperedge relation, up to the r-th fixed hyperedge relation. The mesh mapping may further be constructed by mapping the hyperedges of a first generalized cycle of the set of generalized cycles on vertices of a cell of the mesh. The construction may include mapping the hyperedges of a second generalized cycle of the set of generalized cycles on the vertices of a neighboring cell of the mesh. The first generalized cycle and the second generalized cycle may have at least one hyperedge in common and the at least one hyperedge is mapped on a corresponding at least one vertex of the mesh. This process of mapping hyperedges of generalized cycles of the set of generalized cycles may be repeated until the mapped generalized cycles form the constraining subset. The method may include any of the features described in PCT/EP2020/069416, such as in paragraphs [0101]-[0128] to which specific reference is made, possibly with modifications as described herein.

According to a further embodiment, a quantum operation control layout for controlling a quantum computation on a quantum system is provided. The quantum computation is to be carried out on constituents of the quantum system arranged in accordance with a mesh. The mesh has vertices, first cells and second cells. The vertices of the mesh represent possible sites for the constituents of the quantum system. Each cell of the first cells of the mesh indicates that first quantum interactions between constituents of the quantum system arranged in that cell are possible during the quantum computation. Each cell of the second cells of the mesh indicates that second quantum interactions between constituents of the quantum system arranged in that cell are possible during the quantum computation. The first quantum interactions may be different from the second quantum interactions. The first quantum interactions may correspond to the actions of constraint Hamiltonians, as described herein. The second quantum interactions may correspond to the actions of summand Hamiltonians (such as first order hopping terms or sums thereof) of the exchange Hamiltonian, as described herein. The quantum operation control layout includes data indicating layout vertices of the mesh, data indicating first layout vertex sets, wherein each first layout vertex set consists of layout vertices within a first cell of the mesh, and data indicating one or more second layout vertex sets, wherein each second layout vertex set consists of layout vertices within a second cell of the mesh.

The quantum operation control layout may include data representing weights associated with the layout vertices. The quantum operation control layout may include, for each second layout vertex set, data representing a coefficient associated with that second layout vertex set. The layout vertices may correspond to hyperedges of a hypergraph or of an enlarged hypergraph mapped to the layout vertices according to a mesh mapping. Therein layout vertices of each first layout vertex set may correspond to hyperedges forming a generalized cycle of the hypergraph or of the enlarged hypergraph, and layout vertices of each second layout vertex set may correspond to a fixed hyperedge relation. A fixed hyperedge relation may include a set of hyperedges of the hypergraph. The weights associated with the layout vertices may correspond to weights of the hyperedges of the hypergraph or of the enlarged hypergraph mapped to the layout vertices by the mesh mapping. For each second layout vertex set, the coefficient associated with a second layout vertex set may correspond to a coefficient of a fixed hyperedge relation of a set of one or more hyperedge relations. The quantum operation control layout may include any of the features imparted by the method of determining the quantum operation control layout described herein and may include any of the features described in PCT/EP2020/069416, such as in paragraphs [0129]-[0131] to which specific reference is made, possibly with modifications as described herein.

According to a further embodiment, a method of performing a quantum computation on a quantum system is provided. The quantum computation is carried out on constituents of the quantum system. The method includes providing a quantum operation control layout as described herein. The method includes providing the constituents of the quantum system in a spatial arrangement such that there is a constituent for every layout vertex of the mesh. Therein, for each first layout vertex set, first quantum interactions are possible between constituents corresponding to layout vertices of that first layout vertex set, and, for each second layout vertex set, second quantum interactions are possible between constituents corresponding to layout vertices of that second layout vertex set. The first quantum interactions may be different from the second quantum interactions. The method includes, for each layout vertex associated with a non-zero weight, applying a local field to the constituent corresponding to that layout vertex. The type of local fields may be determined by the problem Hamiltonian, and the strength of the local field may be determined by the non-zero weights. The method includes, for each first layout vertex set, performing first quantum interactions between constituents corresponding to the layout vertices of that first layout vertex set. The method includes, for each second layout vertex set, performing second quantum interactions between constituents corresponding to the layout vertices of that second layout vertex set. The first quantum interactions may correspond to the actions of constraint Hamiltonians, as described herein. The second quantum interactions may correspond to the actions of summand Hamiltonians (such as first order hopping terms or sums thereof) of the exchange Hamiltonian, as described herein. The method includes measuring some or all of the constituents of the quantum system. The method may include, with respect to the quantum operation control layout, any of the features imparted by the method of determining the quantum operation control layout described herein, and may include, with respect to the quantum computation (Hamiltonians and other features), be it analog or digital, any of the features described herein in connection with the performance of a quantum computation. The method may further include any of the features described in PCT/EP2020/069416, possibly with modifications as described herein.

According to a further embodiment, a method for solving a computational problem is provided. The computational problem may be a classical computational problem, e.g., an NP-hard or NP-complete computational problem. The method may include encoding the computational problem into a hypergraph. The method may include encoding one or more side conditions associated with the computational problem into one or more fixed hypergraph relations, as described herein. The hypergraph may be associated with a spin model in that nodes of the hypergraph correspond to spins of the spin model and hyperedges correspond to interactions between the spins of the spin model. The fixed hypergraph relations may correspond to one or more side conditions on the interactions between the spins of the spin model. Finding the lowest energy state of the spin model that is compatible with the one or more side conditions may be equivalent to finding the solution of the computational problem. The method may further include obtaining or determining/generating a quantum operation control layout based on the hypergraph, as described herein. The method for solving the computational problem may include the method of determining the quantum operation control layout as described herein. The method may include performing a quantum computation controlled by the quantum operation control layout. The method for solving the computational problem may include the method of performing the quantum computation as described herein. The method for solving the computational problem may include obtaining the measurement results (read out) of the quantum computation as a trial solution and determining if the trial solution is a solution to the computational problem. If not, the method may include repeating the performance of the quantum computation until a solution is found, or repeating the performance of the quantum computation a finite number of times and selecting the best trial solution as an approximate solution of the computational problem. The method for solving a computational problem may be performed by the classical computing system(s) and quantum computing system(s) described herein, or described in PCT/EP2020/069416, such as in paragraphs [0087]-[0098] and shown in FIGS. 20 and 21 that are specifically incorporated by reference.

According to further embodiments, a system for determining a quantum operation control layout is provided. The system may be a classical computing system, and may include a processing unit/processor and a memory. The system for determining the quantum operation control layout may be configured for carrying out the method of determining the quantum operation control layout according to embodiments described herein. The components of the system may be configured to carry out individual features of the method, as described herein. Additionally, a system for performing a quantum computation is provided. The system for performing the quantum computation may be a quantum processing system, and may include a quantum processing unit, a measurement unit, and any other component as described herein. The system and its components may be configured for carrying out the method or the individual features of the method for performing a quantum computation according to embodiments described herein. The system for performing the quantum computation may be configured to perform the quantum computation under the control of the quantum operation control layout described herein, when the quantum operation control layout is loaded into a memory of the system and/or processed by the quantum processing unit. An embodiment is directed to the quantum operation control layout according to embodiment described herein, which, when executed as a control program by the system for performing the quantum computation, causes this system to carry out the method of performing the quantum computation described herein. Further, a system for solving a computational problem is provided, wherein the system may include at least one classical computing system for encoding the computational problem into a hypergraph, for determining a quantum operation control layout, and for determining if measurement results of a quantum computation contain a solution to the computational problem, and may include a quantum computing system for performing a quantum computation on a quantum system that is controlled by the quantum operation control layout. The system for solving the computational problem and its components may be configured to carry out the method for solving the computational problem, and the individual features of that method, as described herein. Further embodiments are directed to the use of the system for determining the quantum operation control layout to perform the method of determining the quantum operation control layout in accordance with the embodiments described herein, to the use of the system for performing a quantum computation on a quantum system to perform the method of performing the quantum computation as described herein, and to the use of the system for solving a computational problem to perform the method of solving the computational problem as described herein.

According to a further embodiment, a method performing a quantum computation is provided. The method may be a method of performing an adiabatic quantum computation (quantum annealing). The method includes evolving the quantum system from an initial state at an initial time to a final state at a final time. The evolution is in accordance with an intermediate Hamiltonian. The intermediate Hamiltonian may interpolate between an initial Hamiltonian at the initial time and a final Hamiltonian at the final time, wherein the initial Hamiltonian and the final Hamiltonian are different. The intermediate Hamiltonian has a degenerate ground state at a first time between the initial time and the final time. The intermediate Hamiltonian may have a non-degenerate ground state at the final time. The intermediate Hamiltonian may have a non-degenerate ground state at the initial time. The intermediate Hamiltonian may have a non-degenerate ground state at some or all times other than the first time, particularly at times in a time interval around the first time (time interval [t_{first}−ε, t_{first}+ε] for some ε, wherein t_{first} is the first time). The quantum state of the quantum system at the first time is the degenerate ground state of the intermediate Hamiltonian, or an approximation thereof. The quantum state at a later time than the first time is either the ground state or an exited state of the intermediate Hamiltonian, or an approximation of either the one or the other. The dynamics of the evolution of the quantum system induced by the intermediate Hamiltonian determines whether, at the later time, the quantum system is in either the ground state or else in the excited state, or in an approximation of either the one or the other. The final state may be an excited state of the intermediate Hamiltonian at the final time (excited state of the final Hamiltonian). The evolution of the quantum system may be by interactions of the constituents of the quantum system induced by the intermediate Hamiltonian. Therein, the intermediate Hamiltonian may be a time-dependent, weighted sum the initial Hamiltonian, the final Hamiltonian, the exchange Hamiltonian, the driver Hamiltonian as described herein. Therein the final Hamiltonian may be the sum of the problem Hamiltonian and of the short-range Hamiltonian as described herein. The method may include the features of the methods of performing a quantum computation according to any of the other embodiments described herein.

While the foregoing is directed to embodiments, other and further embodiments may be devised without departing from the scope determined by the claims.

1. A method of performing a quantum computation on a quantum system, the method comprising:
encoding a computational problem into a problem Hamiltonian of constituents of the quantum system;
mapping a side condition or side conditions associated with the computational problem to an exchange Hamiltonian of a first part of the constituents of the quantum system;
initializing the constituents of the quantum system in an initial state;
evolving the quantum system by interactions of the constituents of the quantum system, wherein the interactions include interactions determined by a final Hamiltonian, interactions determined by the exchange Hamiltonian, and interactions determined by a driver Hamiltonian, wherein the final Hamiltonian is a sum of the problem Hamiltonian and of a short-range Hamiltonian, and the driver Hamiltonian is a Hamiltonian of a second part of the constituents of the quantum system;
measuring at least a portion of the constituents of the quantum system to obtain a read-out.

2. The method of claim 1, wherein initializing the constituents of the quantum system in the initial state comprises preparing the constituents of the quantum system in a quantum state that is an eigenstate of an initial Hamiltonian or an approximation of the eigenstate, the eigenstate of the initial Hamiltonian preferably being a ground state of the initial Hamiltonian.

3. The method of claim 2, wherein the initial Hamiltonian is a single-body Hamiltonian including a first sum of first summand Hamiltonians and a second sum of second summand Hamiltonians, wherein the first summand Hamiltonians act on the first part of the constituents of the quantum system and the second summand Hamiltonians act on the second part of the constituents of the quantum system, preferably wherein each summand Hamiltonian of the first summand Hamiltonians and of the second summand Hamiltonians is represented by a Pauli \tilde{σ}_{z} operator multiplied by a coefficient, wherein the coefficients of the first summand Hamiltonians are compatible with the side condition or the side conditions associated with the computational problem.

4. The method of claim 1, wherein the exchange Hamiltonian is represented by a sum of nearest-neighbor first order hopping terms.

5. The method of claim 1, wherein evolving the quantum system by interactions of the constituents of the quantum system comprises passing from an initial Hamiltonian of the quantum system to the final Hamiltonian via an intermediate Hamiltonian including a linear combination of the initial Hamiltonian, the final Hamiltonian, the exchange Hamiltonian, and the driver Hamiltonian, preferably by quantum annealing, more preferably comprising adiabatically evolving the initial Hamiltonian into the final Hamiltonian while transiently fading in and then out the driver Hamiltonian and the exchange Hamiltonian.

6. The method of claim 1, wherein evolving the quantum system by interactions of the constituents of the quantum system includes evolving a quantum state of the constituents of the quantum system from the initial state towards an eigenstate of the final Hamiltonian, wherein the eigenstate of the final Hamiltonian is an excited state.

7. The method of claim 1, wherein evolving the quantum system by interactions of the constituents of the quantum system comprises: determining a sequence of unitary operators, wherein the unitary operators in the sequence are taken from the following set of unitary operators: a unitary operator being a function of the problem Hamiltonian, a unitary operator being a function of the short-range Hamiltonian, a unitary operator being a function of the driver Hamiltonian, and a unitary operator being a function of the exchange Hamiltonian, and wherein evolving the quantum system by interactions of the constituents of the quantum system comprises applying the sequence of unitary operators to the quantum system.

8. The method of claim 7, wherein evolving the quantum system by interactions of the constituents of the quantum system and measuring at least a portion of the constituents of the quantum system to obtain a read-out constitutes a round of operations, and wherein there are N rounds of operations, wherein N≥2.

9. The method of claim 1, wherein the initial state and the dynamics of the evolution of the quantum system enforce fulfillment of the side condition or of the side conditions associated with the computational problem during the quantum computation.

10. An apparatus for performing a quantum computation on a quantum system, the apparatus comprising:
the quantum system, including constituents of the quantum system that form a first part and a second part;
an encoder configured for encoding a computational problem into a problem Hamiltonian of the constituents of the quantum system, and configured for mapping a side condition or side conditions associated with the computational problem to an exchange Hamiltonian of the first part of the constituents of the quantum system;
a quantum processing unit configured for:
initializing the constituents of the quantum system in an initial state;
evolving the quantum system by interactions of the constituents of the quantum system, wherein the interactions include interactions determined by a final Hamiltonian, the exchange Hamiltonian, and a driver Hamiltonian, wherein the final Hamiltonian is the sum of the problem Hamiltonian and of a short-range Hamiltonian, and the driver Hamiltonian is a Hamiltonian of the second part of the constituents of the quantum system;
a measurement unit configured for measuring at least a portion of the constituents of the quantum system to obtain a read-out.

11. A method of performing a quantum computation on a quantum system, wherein the quantum computation is carried out on constituents of the quantum system, the method comprising:
providing a quantum operation control layout for controlling the quantum computation on the quantum system that is arranged in accordance with a mesh having vertices, first cells and second cells, wherein the vertices of the mesh represent possible sites for the constituents of the quantum system, wherein each cell of the first cells of the mesh indicates that first quantum interactions between constituents of the quantum system arranged in that cell are possible during the quantum computation, and wherein each cell of the second cells of the mesh indicates that second quantum interactions between constituents of the quantum system arranged in that cell are possible during the quantum computation, the quantum operation control layout comprising: data indicating layout vertices of the mesh, data indicating first layout vertex sets, wherein each first layout vertex set consists of layout vertices within a first cell of the mesh, and data indicating one or more second layout vertex sets, wherein each second layout vertex set consists of layout vertices within a second cell of the mesh;
providing the constituents of the quantum system in a spatial arrangement such that there is a constituent for every layout vertex of the mesh;
for each layout vertex associated with a non-zero weight, applying a local field to the constituent corresponding to that layout vertex, the local field being determined by a problem Hamiltonian;
for each first layout vertex set, performing first quantum interactions between constituents corresponding to the layout vertices of that first layout vertex set, wherein the first quantum interactions are determined by a short-range Hamiltonian;
for each second layout vertex set, performing second quantum interactions between constituents corresponding to the layout vertices of that second layout vertex set, wherein the second quantum interactions are determined by an exchange Hamiltonian; and
measuring some or all of the constituents of the quantum system.

12. A method of determining a quantum operation control layout for a quantum computation on a quantum system, wherein the quantum computation is to be carried out on constituents of the quantum system arranged in accordance with a mesh having vertices and first cells and second cells, wherein the vertices of the mesh represent possible sites for the constituents of the quantum system, wherein each cell of the first cells indicates that first quantum interactions between constituents of the quantum system arranged in that cell are possible during the quantum computation, and wherein each cell of the second cells indicates that second quantum interactions between constituents of the quantum system arranged in that cell are possible during the quantum computation the method comprising:
providing a data set including data representing hyperedges of a hypergraph and including data representing a set of one or more fixed hyperedge relations, wherein a fixed hyperedge relation includes a set of hyperedges of the hypergraph;
determining a set of generalized cycles, the generalized cycles containing hyperedges of the hypergraph or containing hyperedges of an enlarged hypergraph, the enlarged hypergraph at least including the hyperedges of the hypergraph and an additional hyperedge, wherein a maximal length of generalized cycles of the set of generalized cycles is not greater than a maximal vertex number of the first cells of the mesh;
determining a mesh mapping that maps data representing the hyperedges of the hypergraph or of the enlarged hypergraph to the vertices of the mesh, wherein each generalized cycle of a constraining subset of the set of generalized cycles consists of hyperedges mapped to a cell of the first cells of the mesh and wherein each fixed hyperedge relation of the set of one or more fixed hyperedge relations consists of hyperedges mapped to a cell of the second cells of the mesh; and
generating the quantum operation control layout, the quantum operation control layout including data indicating layout vertices of the mesh, wherein each layout vertex corresponds to a hyperedge mapped according to the mesh mapping, including data indicating first layout vertex sets, each first layout vertex set consisting of layout vertices within a cell of the first cells of the mesh that correspond to a generalized cycle of the constraining subset of generalized cycles, and including data indicating one or more second layout vertex sets, each second layout vertex set consisting of layout vertices within a cell of the second cells of the mesh that correspond to a fixed hyperedge relation of the set of one or more fixed hyperedge relations.

13. The method according to claim 12, wherein determining the mesh mapping comprises considering each fixed hyperedge relation with priority over any generalized cycle when mapping the data representing the hyperedges of the hypergraph or of the enlarged hypergraph to the vertices of the mesh.

14. A quantum operation control layout for controlling a quantum computation on a quantum system, wherein the quantum computation is to be carried out on constituents, of the quantum system arranged in accordance with a mesh having vertices, first cells and second cells, wherein the vertices of the mesh represent possible sites for the constituents of the quantum system, wherein each cell of the first cells of the mesh indicates that first quantum interactions between constituents of the quantum system arranged in that cell are possible during the quantum computation, and wherein each cell of the second cells of the mesh indicates that second quantum interactions between constituents of the quantum system arranged in that cell are possible during the quantum computation, the quantum operation control layout comprising:
data indicating layout vertices of the mesh, and
data indicating first layout vertex sets, wherein each first layout vertex set consists of layout vertices within a first cell of the mesh, and
data indicating one or more second layout vertex sets, wherein each second layout vertex set consists of layout vertices within a second cell of the mesh.

15. The quantum operation control layout according to claim 14, wherein at least one of the following applies:
the quantum operation control layout comprises data representing weights associated with the layout vertices;
the quantum operation control layout comprises, for each second layout vertex set, data representing a coefficient associated with that second layout vertex set;
the layout vertices correspond to hyperedges of a hypergraph or of an enlarged hypergraph mapped to the layout vertices according to a mesh mapping, wherein layout vertices of each first layout vertex set correspond to hyperedges forming a generalized cycle of the hypergraph or of the enlarged hypergraph and wherein layout vertices of each second layout vertex set correspond to a fixed hyperedge relation, wherein a fixed hyperedge relation includes a set of hyperedges of the hypergraph;
the weights associated with the layout vertices correspond to weights of the hyperedges of the hypergraph or of the enlarged hypergraph mapped to the layout vertices by the mesh mapping; and,
for each second layout vertex set, the coefficient associated with a second layout vertex set corresponds to a coefficient of a fixed hyperedge relation of a set of one or more hyperedge relations.
